(19) United States
(12) Patent Application Publication
(10) Pub. No.: US 2008/0192251 A1
(43) Pub. Date: Aug. 14, 2008

(54) Method For Determining Residues in Plastics

(75) Inventors: Samy Abdel-Baky, Cary, NC (US); Detlef Dohnert, Ludwigshafen (DE); Jay Jones, Fuquay Varina, NC (US); Adam Finch, Mebane, NC (US)

Correspondence Address: ROTHWELL, FIGG, ERNST & MANBECK, P.C., 1425 K STREET, N.W., SUITE 800, WASHINGTON, DC, 20005, US

(73) Assignee: BASF AKTIENGESELLSCHAFT, Ludwigshafen (DE)

(21) Appl. No.: 11/915,482

(22) PCT Filed: May 24, 2006
(86) PCT No.: PCT/EP2006/004999

§ 371 Date: Nov. 26, 2007

Related U.S. Application Data
(60) Provisional application No. 60/683,781, filed on May 24, 2005.
(60) Provisional application No. 60/701,483, filed on Jul. 22, 2005.

(30) Foreign Application Priority Data
Jun. 7, 2005 (EP) 05012217.5

(51) Int. Cl. G01J 3/00

(52) U.S. Cl. 356/326

(57) ABSTRACT

The present invention relates to a method for determining dangerous or pesticidal residues in plastics, which comprises processing a plastic sample to a fine powder, converting the powder into a form accessible for determining the analyte, and determining the analyte. The present invention is thus concerned with the analysis of plastics, in particular trace analysis of residues in plastics. The method advantageously allows the use of microextraction techniques and thus a high sample throughput. The method is especially useful for determining whether or not a plastic sample such as agricultural waste plastics contain pesticidal residues.

The present invention relates to a method for determining dangerous or pesticidal residues in plastics. The present invention is thus concerned with the analysis of plastics, in particular the trace analysis of such residues in plastics. The method is especially useful for determining whether or not a plastic sample such as agricultural waste plastics contain pesticidal residues.

Analyzing for traces of certain residues in complex matrices, e. g. food, organic material, post consumer resins and waste, gains more and more importance and is in many instances required by various stakeholders.

The presence of classified residues triggers the classification as hazardous or non hazardous packaging waste. The classification has a direct impact on the requirements for collection, handling and final disposal. For instance, in the European Union the Waste Framework Directive, 91/156EEC, the Hazardous Waste Directive, 91/689EC, the European Waste Catalogue (EWC), 2000/532/EC, regulate the management and classification of waste. In particular, the EWC clearly specifies the threshould values that trigger the classification of waste as hazardous or non hazardous, depending on the concentration of certain residues in the waste stream.

For instance, each year, over 100,000 tons of crop protection product packaging enters the market; a small amount of the empty packs are recovered for recycling into new products or energy.

Currently, industry is taking a conservative approach toward the recycling of agricultural waste plastics. In fact, most recovered agrochemical containers are simply converted to energy while only a few are collected and finally recycled to certain end-use products such as industrial plastic pallets, truck sub-flow components and scaffold nailing strips.

Recycling agricultural waste plastics such as used agrochemical containers requires special care because of the very nature of the products they once contained. Trace amounts of agrochemicals may be migrated into the walls of plastic containers and may also be detected in products manufactured from the recycled plastics.

JP-A 04/172248 (see also Patent Abstracts of Japan, vol. 016, no. 481 (P-1431) 1992) describes a method of determining the amount of PVC-based resin by measuring HCl concentration after thermal decomposition of a grinded mixed plastic waste.

Camel (Analusis Magazine, 1998, 26, M 99-M 111) discusses supercritical fluid extraction as a useful method for pesticides determination. Drastic conditions (75° C., 200 bar) were required for extracting chlorinated pesticides from postconsumer recycled plastics.

DE 42 07 370 describes a method for recycling plastic containers that are contaminated with plant protection agents. The method comprises shredding the plastic material and treating the shredded material with a solvent such as cyclohexane in order to remove the plant protection agents. WO 2005/037513 likewise is concerned a method for recycling plastic containers. This method comprises analysing the degree of contamination before the decontamination process starts.

All these methods are cumbersome and not suited for high-throughput analysis.

In order to promote the recycling of used agrochemical containers and other agricultural waste plastics, there is thus a need for methods which allow reliable and efficient identification of dangerous or pesticidal residues associated with plastics and in particular agricultural waste plastics.

It has now been found that processing plastics to a fine powder allows a reliable and efficient determination of whether or not said plastics contain certain residues.

The present invention thus relates to a method for determining a dangerous analyte in plastics, which comprises processing a plastic sample to a fine powder, converting the powder or a portion thereof into a form accessible for determining the analyte, and determining the analyte.

The method of the present invention has several advantages as compared to conventional residue analysis of plastics such as reduced solvent usage, improved sample throughput, reduction of space allocation in the laboratory and reduced analysis cost.

For the purposes of this invention, a dangerous analyte (or a dangerous compound) is any substance, for instance a compound as it occurs in the natural state or as produced by industry, that is very toxic (which in very low quantities causes death or chronic damage to health when inhaled, swallowed or in contact with skin); toxic (which in low quantities causes death or acute or chronic damage to health when inhaled, swallowed or in contact with skin); harmful (which may cause death or acute or chronic damage to health when inhaled, swallowed or in contact with skin); irritant (which, through immediate or prolonged or repeated contact with the skin or mucous membrane, may cause inflammation); sensitizing (which, if they are inhaled or if they penetrate the skin, are capable of eliciting a reaction of hypersensitisation such that on further exposure to the substance, characteristic adverse effects are produced); carcinogenic (which, if they are inhaled or ingested or if they penetrate the skin, may induce cancer or increase its incidence); mutagenic (which, if they are inhaled or ingested or if they penetrate the skin, may induce heritable genetic defects or increase their incidence); toxic for reproduction (which, if they are inhaled or ingested or if they penetrate the skin, may produce, or increase the incidence of, non-heritable adverse effects in the progeny and/or an impairment of male or female reproductive functions or capacity); dangerous for the environment (which, where they enter the environment, would or could present an immediate or delayed danger for one or more components of the aquatic environment).

Very toxic by inhalation means having an inhalation LC₅₀ in rat of ≦0.25 mg/L/4 h for aerosols or particulates, or an inhalation LC₅₀ in rat of ≦0.5 mg/L/4 h for gases or vapours.

Very toxic if swallowed means having an oral LD₅₀ in rat of ≦25 mg/kg, less than 100% survival at an oral dosage of 5 mg/kg in rat by the fixed dose procedure, or a high mortality at oral doses of ≦25 mg/kg by the acute toxic class method.

Very toxic in contact with skin means having a dermal LD₅₀ in rat or rabbit of ≦50 mg/kg.

Toxic by inhalation means having an inhalation LC₅₀ in rat of 0.25<LC₅₀≦1 mg/L/4 h for aerosols or particulates, or an inhalation LC₅₀ in rat of 0.5<LC₅₀≦2 mg/L/4 h for gases or vapours.

Toxic if swallowed means having an oral LC₅₀ in rat of 25<LD₅₀≦200 mg/kg, 100% survival but evident toxicity at a oral discriminating dose of 5 mg/kg, or a high mortality in the oral dose range of >25 to ≦200 mg/kg in rat by the acute toxic class method.

The discriminating dose is the dose which causes evident toxicity but not mortality.

Toxic in contact with skin means having a dermal LD₅₀ in rat or rabbit of 50<LD₅₀≦400 mg/kg.

Harmful by inhalation means having an inhalation LD₅₀ in rat of 1<LC₅₀≦5 mg/L/4 h for aerosols or particulates, or an inhalation LC₅₀ of 2<LC₅₀≦20 mg/L/4 h for gases or vapours.

Harmful if swallowed means having an oral LD₅₀ of 200<LD₅₀≦2000 mg/kg, 100% survival but evident toxicity at a oral discriminating dose in rat of 50 mg/kg, less than 100% survival at a oral dose of 500 mg/kg in rat by the fixed dose procedure, or a high mortality in the oral dose range of >200 to ≦2000 mg/kg by the acute toxic class method.

Harmful in contact with skin means having a dermal LD₅₀ in rat or rabbit of 400<LD₅₀≦2000 mg/kg.

Environment means aquatic environment and non-aquatic environment. Substances with immediate or delayed danger for one or more components of the aquatic environment include substances that are very toxic to aquatic organisms (96 h LC₅₀ (for fish): ≦1 mg/L, or 48 h EC₅₀ (for Daphnia): ≦1 mg/L, or 72 h IC₅₀ (for algae): ≦1 mg/L); toxic to aquatic organisms (96 h LC₅₀ (for fish): 1 mg/L<LC₅₀≦10 mg/L, or 48 h EC₅₀ (for Daphnia): 1 mg/L<EC₅₀≦10 mg/L, or 72 h IC₅₀ (for algae): 1 mg/L<IC₅₀≦10 mg/L); or harmful to aquatic organisms (96 h LC₅₀ (for fish): 10 mg/L<LC₅₀≦100 mg/L, or 48 h EC₅₀ (for Daphnia): 10 mg/L<EC₅₀≦100 mg/L, or 72 h IC₅₀ (for algae): 10 mg/L<IC₅₀≦100 mg/L).

The acute toxic class method and other suitable method to determine whether a compound is classified as being a dangerous substance are defined in Annex V of the consolidated version of directive 67/548/EEC (e.g. as method B.1 tris).

According to a particular embodiment of the present invention, a dangerous analyte is a compound that qualifies as a dangerous analyte in accordance with the classification given in directive 1999/45/EC, Annex II, part A, and in directive 67/548/EEC Annex I & V, VI.

Compound as used herein means a substance that comprises molecules in which two more atoms of at least two elements are connected by chemical bond(s). Compounds thus do not include elements as such, e.g. elemental metals. Organic compounds are of particular interest according to the present invention.

According to a particular embodiment of the present invention, the dangerous analyte is a substance that qualifies as very toxic (T+), toxic (T), harmful (Xn) or dangerous for the environment (N). Of particular importance are very toxic substances.

Dangerous analytes include in particular those which are at risk of occurring in plastics and especially in plastic packaging material, especially T+ compounds, e.g. 2-ethylhexanoic acid chloride, isononanoic acid chloride, neodecanoic acid chloride, hydrofluoric acid, atropine sulfate, scopolamine hydrobromide, β-acetyldigoxine, epinephrine bitartrate, pilocarpine hydrochloride, hyoscyamine sulfate, hyoscyamine hydrobromide, atropine methylnitrate, alkylated phenol, dimethylsulfate, p-chloro-o-nitroaniline, 5-chloro-2-nitroaniline.

According to a further aspect, the present invention relates to a method for determining a pesticidal analyte in plastics, which comprises processing a plastic sample to a fine powder, converting the powder or a portion thereof into a form accessible for determining the analyte, and determining the analyte. A pesticidal analyte can be a pesticide, or a transformation product of a pesticide or an pesticidal adjuvant or auxiliary.

The term pesticide is used to mean a large variety of crop controlling agents. A pesticide may be any substance or mixture of substances intended for preventing, destroying, repelling, or mitigating any pest. Pests can be insects, mice and other animals, unwanted plants (weeds), fungi, or microorganisms like bacteria and viruses. Pesticides in particular include avicides, antifeedants, acaricides, bactericides, bird repellents, chemosterilants, defoliants, desiccants, fungicides, herbicides, herbicide safeners, insect attractants, insecticides, insect repellents, mammal repellents, mating disrupters, molluscicides, nematicides, plant activators, plant growth regulators, rodenticides, synergists, and virucides.

Based on chemical classes, pesticides include in particular acylalanine fungicides, acylamino acid fungicides, aliphatic amide organothiophosphate insecticides, aliphatic nitrogen fungicides, aliphatic organothiophosphate insecticides, amide fungicides, amide herbicides, anilide fungicides, anilide herbicides, antiauxins, antibiotic acaricides, antibiotic fungicides, antibiotic herbicides, antibiotic insecticides, antibiotic nematicides, aromatic acid herbicides, aromatic fungicides, arsenical herbicides, arsenical insecticides, arylalanine herbicides, aryloxyphenoxypropionic herbicides, auxins, avermectin acaricides, avermectin insecticides, benzamide fungicides, benzanilide fungicides, benzimidazole fungicides, benzimidazole precursor fungicides, benzimidazolylcarbamate fungicides, benzofuranyl alkylsulfonate herbicides, benzofuranyl methylcarbamate insecticides, benzoic acid herbicides, benzothiazole fungicides, benzothiopyran organothiophosphate insecticides, benzotriazine organothiophosphate insecticides, benzoylcyclohexanedione herbicides, bipyridylium herbicides, botanical insecticides, botanical rodenticides, bridged diphenyl acaricides, bridged diphenyl fungicides, carbamate acaricides, carbamate fungicides, carbamate herbicides, carbamate insecticides, carbamate nematicides, carbanilate fungicides, carbanilate herbicides, chitin synthesis inhibitors, chloroacetanilide herbicides, chloronicotinyl insecticides, chloropyridine herbicides, chlorotriazine herbicides, conazole fungicides, copper fungicides, coumarin rodenticides, cyclic dithiocarbamate fungicides, cyclodiene insecticides, cyclohexene oxime herbicides, cyclopropylisoxazole herbicides, cytokinins, defoliants, diacylhydrazine insecticides, dicarboximide fungicides, dicarboximide herbicides, dichlorophenyl dicarboximide fungicides, dimethylcarbamate insecticides, dinitroaniline herbicides, dinitrophenol acaricides, dinitrophenol fungicides, dinitrophenol herbicides, dinitrophenol insecticides, diphenyl ether herbicides, dithiocarbamate fungicides, dithiocarbamate herbicides, ethylene releasers, fluorine insecticides, formamidine acaricides, formamidine insecticides, fumigant insecticides, furamide fungicides, furanilide fungicides, gibberellins, growth inhibitors, growth retardants, growth stimulators, halogenated aliphatic herbicides, heterocyclic organothiophosphate insecticides, imidazole fungicides, imidazolinone herbicides, indandione rodenticides, inorganic fungicides, inorganic herbicides, inorganic insecticides, inorganic mercury fungicides, inorganic rodenticides, insect growth regulators, isoindole organothiophosphate insecticides, isoxazole organothiophosphate insecticides, juvenile hormone mimics, juvenile hormones, macrocyclic lactone acaricides, macrocyclic lactone insecticides, mercury fungicides, methoxytriazine herbicides, methylthiotriazine herbicides, milbemycin acaricides, milbemycin insecticides, mite growth regulators, morphactins, morpholine fungicides, moulting hormone agonists, moulting hormones, moulting inhibitors, nereistoxin analogue insecticides, nicotinoid insecticides, nitrile herbicides, nitroguanidine insecticides, nitromethylene insecticides, nitrophenyl ether herbicides, organochlorine acaricides, organochlorine insecticides, organochlorine rodenticides, organomercury fungicides, organophosphate acaricides, organophosphate insecticides, organophosphate nematicides, organophosphorus acaricides, organophosphorus fungicides, organophosphorus herbicides, organophosphorus insecticides, organophosphorus nematicides, organophosphorus rodenticides, organothiophosphate acaricides, organothiophosphate insecticides, organothiophosphate nematicides, organotin acaricides, organotin fungicides, oxadiazine insecticides, oxathiin fungicides, oxazole fungicides, oxime carbamate acaricides, oxime carbamate insecticides, oxime carbamate nematicides, oxime organothiophosphate insecticides, phenoxy herbicides, phenoxyacetic herbicides, phenoxybutyric herbicides, phenoxypropionic herbicides, phenyl ethylphosphonothioate insecticides, phenyl methylcarbamate insecticides, phenyl organothiophosphate insecticides, phenyl phenylphosphonothioate insecticides, phenylenediamine herbicides, phenyl pyrazolyl ketone herbicides, phenylsulfamide acaricides, phenylsulfamide fungicides, phenylurea herbicides, phosphonate acaricides, phosphonate insecticides, phosphonothioate insecticides, phosphoramidate insecticides, phosphoramidothioate acaricides, phosphoramidothioate insecticides, phosphorodiamide acaricides, phosphorodiamide insecticides, phthalic acid herbicides, phthalimide acaricides, phthalimide fungides, phthalimide insecticides, picolinic acid herbicides, polymeric dithiocarbamate fungicides, polysulfide fungicides, precocenes, pyrazole acaricides, pyrazole fungicides, pyrazole insecticides, pyrazolopyrimidine organothiophosphate insecticides, pyrazolyloxyacetophenone herbicides, pyrazolylphenyl herbicides, pyrethroid acaricides, pyrethroid ester acaricides, pyrethroid ester insecticides, pyrethroid ether acaricides, pyrethroid ether insecticides, pyrethroid insecticides, pyridazine herbicides, pyridazinone herbicides, pyridine fungicides, pyridine herbicides, pyridine organothiophosphate insecticides, pyridylmethylamine insecticides, pyrimidinamine acaricides, pyrimidinamine insecticides, pyrimidinamine rodenticides, pyrimidine fungicides, pyrimidine organothiophosphate insecticides, pyrimidinediamine herbicides, pyrimidinyloxybenzoic acid herbicides, pyrimidinylsulfonylurea herbicides, pyrimidinylthiobenzoic acid herbicides, pyrrole acaricides, pyrrole fungicides, pyrrole insecticides, quaternary ammonium herbicides, quinoline fungicides, quinolinecarboxylic acid herbicides, quinone fungicides, quinoxaline acaricides, quinoxaline fungicides, quinoxaline organothiophosphate insecticides, strobilurin fungicides, sulfite ester acaricides, sulfonamide fungicides, sulfonamide herbicides, sulfonanilide fungicides, sulfonanilide herbicides, sulfonylurea herbicides, tetrazine acaricides, tetronic acid acaricides, tetronic acid insecticides, thiadiazole organothiophosphate insecticides, thiadiazolylurea herbicides, thiazole fungicides, thiocarbamate acaricides, thiocarbamate fungicides, thiocarbamate herbicides, thiocarbonate herbicides, thiophene fungicides, thiourea acaricides, thiourea herbicides, thiourea rodenticides, triazine fungicides, triazine herbicides, triazinone herbicides, triazinylsulfonylurea herbicides, triazole fungicides, triazole herbicides, triazole organothiophosphate insecticides, triazolone herbicides, triazolopyrimidine herbicides, uracil herbicides, urea fungicides, urea herbicides, urea insecticides, urea rodenticides, valinamide fungicides, xylylalanine fungicides.

In particular, the pesticide is selected from the group of fungicides, herbicides and insecticides.

Herbicides include, for instance, amide herbicides, such as allidochlor, beflubutamid, benzadox, benzipram, bromobutide, cafenstrole, CDEA, chlorthiamid, cyprazole, dimethenamid, dimethenamid-P, diphenamid, epronaz, etnipromid, fentrazamide, flupoxam, fomesafen, halosafen, isocarbamid, isoxaben, napropamide, naptalam, pethoxamid, propyzamide, quinonamid, tebutam; especially anilide herbicides, such as chloranocryl, cisanilide, clomeprop, cypromid, diflufenican, etobenzanid, fenasulam, flufenacet, flufenican, mefenacet, mefluidide, metamifop, monalide, naproanilide, pentanochlor, picolinafen, propanil; in particular arylalanine herbicides, such as benzoylprop, flamprop, flamprop-M; chloroacetanilide herbicides, such as acetochlor, alachlor, butachlor, butenachlor, delachlor, diethatyl, dimethachlor, metazachlor, metolachlor, S-metolachlor, pretilachlor, propachlor, propisochlor, prynachlor, terbuchlor, thenylchlor, xylachlor; and sulfonanilide herbicides, such as benzofluor, cloransulam, diclosulam, florasulam, flumetsulam, metosulam, perfluidone, pyrimisulfan, profluazol; and sulfonamide herbicides, such as asulam, carbasulam, fenasulam, oryzalin, penoxsulam; antibiotic herbicides, such as bilanafos; aromatic acid herbicides; especially benzoic acid herbicides, such as chloramben, dicamba, 2,3,6-TBA, tricamba; in particular pyrimidinyloxybenzoic acid herbicides, such as bispyribac, pyriminobac; and pyrimidinylthiobenzoic acid herbicides, such as pyrithiobac; phthalic acid herbicides, such as chlorthal; picolinic acid herbicides, such as aminopyralid, clopyralid, picloram; and quinolinecarboxylic acid herbicides, such as quinclorac, quinmerac; arsenical herbicides, such as cacodylic acid, CMA, DSMA, hexaflurate, MAA, MAMA, MSMA, potassium arsenite, sodium arsenite; benzoylcyclohexanedione herbicides, such as mesotrione, sulcotrione; benzofuranyl alkylsulfonate herbicides, such as benfuresate, ethofumesate; carbamate herbicides, such as asulam, carboxazole, chlorprocarb, dichlormate, fenasulam, karbutilate, terbucarb; carbanilate herbicides, such as barban, BCPC, carbasulam, carbetamide, CEPC, chlorbufam, chlorpropham, CPPC, desmedipham, phenisopham, phenmedipham, phenmedipham-ethyl, propham, swep; cyclohexene oxime herbicides, such as alloxydim, butroxydim, clethodim, cloproxydim, cycloxydim, profoxydim, sethoxydim, tepraloxydim, tralkoxydim; cyclopropylisoxazole herbicides, such as isoxachlortole, isoxaflutole; dicarboximide herbicides, such as benzfendizone, cinidon-ethyl, flumezin, flumiclorac, flumioxazin, flumipropyn; dinitroaniline herbicides, such as benfluralin, butralin, dinitramine, ethalfluralin, fluchloralin, isopropalin, methalpropalin, nitralin, oryzalin, pendimethalin, prodiamine, profluralin, trifluralin; dinitrophenol herbicides, such as dinofenate, dinoprop, dinosam, dinoseb, dinoterb, DNOC, etinofen, medinoterb; diphenyl ether herbicides, such as ethoxyfen; especially nitrophenyl ether herbicides, such as acifluorfen, aclonifen, bifenox, chlomethoxyfen, chlornitrofen, etnipromid, fluorodifen, fluoroglycofen, fluoronitrofen, fomesafen, furyloxyfen, halosafen, lactofen, nitrofen, nitrofluorfen, oxyfluorfen; dithiocarbamate herbicides, such as dazomet, metam; halogenated aliphatic herbicides, such as alorac, chloropon, dalapon, flupropanate, hexachloroacetone, iodomethane, methyl bromide, monochloroacetic acid, SMA, TCA; imidazolinone herbicides, such as imazamethabenz, imazamox, imazapic, imazapyr, imazaquin, imazethapyr; inorganic herbicides, such as ammonium sulfamate, borax, calcium chlorate, copper sulfate, ferrous sulfate, potassium azide, potassium cyanate, sodium azide, sodium chlorate, sulfuric acid; nitrile herbicides, such as bromobonil, bromoxynil, chloroxynil, dichlobenil, iodobonil, ioxynil, pyraclonil; organophosphorus herbicides, such as amiprofos-methyl, anilofos, bensulide, bilanafos, butamifos, 2,4-DEP, DMPA, EBEP, fosamine, glufosinate, glyphosate, piperophos; phenoxy herbicides, such as bromofenoxim, clomeprop, 2,4-DEB, 2,4-DEP, difenopenten, disul, erbon, etnipromid, fenteracol, trifopsime; especially phenoxyacetic herbicides, such as 4-CPA, 2,4-D, 3,4-DA, MCPA, MCPA-thioethyl, 2,4,5-T; phenoxybutyric herbicides, such as 4-CPB, 2,4-DB, 3,4-DB, MCPB, 2,4,5-TB; and phenoxypropionic herbicides, such as cloprop, 4-CPP, dichlorprop, dichlorprop-P, 3,4-DP, fenoprop, mecoprop, mecoprop-P; in particular aryloxyphenoxypropionic herbicides, such as chlorazifop, clodinafop, clofop, cyhalofop, diclofop, fenoxaprop, fenoxaprop-P, fenthiaprop, fluazifop, fluazifop-P, haloxyfop, haloxyfop-P, isoxapyrifop, metamifop, propaquizafop, quizalofop, quizalofop-P, trifop; phenylenediamine herbicides, such as dinitramine, prodiamine; phenyl pyrazolyl ketone herbicides, such as benzofenap, pyrazolynate, pyrazoxyfen, topramezone; pyrazolylphenyl herbicides, such as fluazolate, pyraflufen; pyridazine herbicides, such as credazine, pyridafol, pyridate; pyridazinone herbicides, such as brompyrazon, chloridazon, dimidazon, flufenpyr, mefflurazon, norflurazon, oxapyrazon, pydanon; pyridine herbicides, such as aminopyralid, cliodinate, clopyralid, dithiopyr, fluroxypyr, haloxydine, picloram, picolinafen, pyriclor, thiazopyr, triclopyr; pyrimidinediamine herbicides, such as iprymidam, tioclorim; quaternary ammonium herbicides, such as cyperquat, diethamquat, difenzoquat, diquat, morfamquat, paraquat; thiocarbamate herbicides, such as butylate, cycloate, di-allate, EPTC, esprocarb, ethiolate, isopolinate, methiobencarb, molinate, orbencarb, pebulate, prosulfocarb, pyributicarb, sulfallate, thiobencarb, tiocarbazil, tri-allate, vernolate; thiocarbonate herbicides, such as dimexano, EXD, proxan; thiourea herbicides, such as methiuron; triazine herbicides, such as dipropetryn, triaziflam, trihydroxytriazine; especially chlorotriazine herbicides, such as atrazine, chlorazine, cyanazine, cyprazine, eglinazine, ipazine, mesoprazine, procyazine, proglinazine, propazine, sebuthylazine, simazine, terbuthylazine, trietazine; methoxytriazine herbicides, such as atraton, methometon, prometon, secbumeton, simeton, terbumeton; and methylthiotriazine herbicides, such as ametryn, aziprotryne, cyanatryn, desmetryn, dimethametryn, methoprotryne, prometryn, simetryn, terbutryn; triazinone herbicides, such as ametridione, amibuzin, hexazinone, isomethiozin, metamitron, metribuzin; triazole herbicides, such as amitrole, cafenstrole, epronaz, flupoxam; triazolone herbicides, such as amicarbazone, carfentrazone, flucarbazone, propoxycarbazone, sulfentrazone; triazolopyrimidine herbicides, such as cloransulam, diclosulam, florasulam, flumetsulam, metosulam, penoxsulam; uracil herbicides, such as butafenacil, bromacil, flupropacil, isocil, lenacil, terbacil; urea herbicides, such as benzthiazuron, cumyluron, cycluron, dichloralurea, diflufenzopyr, isonoruron, isouron, methabenzthiazuron, monisouron, noruron; especially phenylurea herbicides, such as anisuron, buturon, chlorbromuron, chloreturon, chlorotoluron, chloroxuron, daimuron, difenoxuron, dimefuron, diuron, fenuron, fluometuron, fluothiuron, isoproturon, linuron, methiuron, methyldymron, metobenzuron, metobromuron, metoxuron, monolinuron, monuron, neburon, parafluron, phenobenzuron, siduron, tetrafluron, thidiazuron; sulfonylurea herbicides; in particular pyrimidinylsulfonylurea herbicides, such as amidosulfuron, azimsulfuron, bensulfuron, chlorimuron, cyclosulfamuron, ethoxysulfuron, flazasulfuron, flucetosulfuron, flupyrsulfuron, foramsulfuron, halosulfuron, imazosulfuron, mesosulfuron, nicosulfuron, orthosulfamuron, oxasulfuron, primisulfuron, pyrazosulfuron, rimsulfuron, sulfometuron, sulfosulfuron, trifloxysulfuron; and triazinylsulfonylurea herbicides, such as chlorsulfuron, cinosulfuron, ethametsulfuron, iodosulfuron, metsulfuron, prosulfuron, thifensulfuron, triasulfuron, tribenuron, triflusulfuron, tritosulfuron; and thiadiazolylurea herbicides, such as buthiuron, ethidimuron, tebuthiuron, thiazafluron, thidiazuron; and unclassified herbicides, such as acrolein, allyl alcohol, azafenidin, benazolin, bentazone, benzobicyclon, buthidazole, calcium cyanamide, cambendichlor, chlorfenac, chlorfenprop, chlorflurazole, chlorflurenol, cinmethylin, clomazone, CPMF, cresol, ortho-dichlorobenzene, dimepiperate, endothal, fluoromidine, fluridone, flurochloridone, flurtamone, fluthiacet, indanofan, methazole, methyl isothiocyanate, nipyraclofen, OCH, oxadiargyl, oxadiazon, oxaziclomefone, pentachlorophenol, pentoxazone, phenylmercury acetate, pinoxaden, prosulfalin, pyribenzoxim, pyriftalid, quinoclamine, rhodethanil, sulglycapin, thidiazimin, tridiphane, trimeturon, tripropindan, tritac.

According to a particular embodiment of the present invention, herbicides include:
1,3,4-thiadiazoles, such as buthidazole and cyprazole;
amides, such as allidochlor, benzoylprop-ethyl, bromobutide, chlorthiamid, dimepiperate, dimethenamid, diphenamid, etobenzanid, flamprop, flamprop-methyl, fosamine, isoxaben, metazachlor, monalide, naptalam, pronamide, propanil, propyzamide, quinonamid;
aminotriazoles, such as amitrole,
anilides, such as anilofos, mefenacet, pentanochlor;
aryloxyalkanoic acids, such as 2,4-D, 2,4-DB, clomeprop, dichlorprop, dichlorprop-P, fenoprop, fluroxypyr, MCPA, MCPB, mecoprop, mecoprop-P, napropamide, napropanilide, triclopyr;
benzoic acids, such as chloramben, dicamba;
benzothiadiazinones, such as bentazone;
bleachers, such as clomazone, diflufenican, fluorochloridone, flupoxam, fluridone, karbutilate, pyrazolate, sulcotrione, mesotrione;
carbamates, such as asulam, carbetamide, chlorbufam, chlorpropham, desmedipham, phenmedipham, vernolate;
quinolinic acids, such as quinclorac, quinmerac;
dichloropropionic acids, such as dalapon;
dihydrobenzofurans, such as ethofumesate;
dihydrofuran-3-ones, such as flurtamone;
dinitroanilines, such as benefin, butralin, dinitramine, ethalfluralin, fluchloralin, isopropalin, nitralin, oryzalin, pendimethalin, prodiamine, profluralin, trifluralin;
dinitrophenols, such as bromofenoxim, dinoseb, dinoseb-acetate, dinoterb, DNOC, minoterb-acetate;
diphenyl ethers, such as aciflurofen, acifluorfen-sodium, aclonifen, bifenox, chlornitrofen, difenoxuran, ethoxyfen, fluorodifen, fluoroglycofen-ethyl, fomesafen, furyloxyfen, lactofen, nitrofen, nitrofluorfen, oxyfluorfen;
ureas, such as benzthiazuron, DCU, diflufenzopyr, methabenzthiazuron;
imidazolinones, such as imazamethapyr, imazapyr, imazaquin, imazethabenz-methyl, imazethapyr, imazapic, imazamox;
oxadiazoles, such as methazole, oxadiargyl, oxadiazon;
oxiranes, such as tridiphane;
phenols, such as bromoxynil, ioxynil;
phenoxyphenoxypropionic acid esters, such as clodinafop, cyhalofop-butyl, diclofop-methyl, fenoxaprop-ethyl, fenoxaprop-p-ethyl, fenthiaprop-ethyl, fluazifop-butyl, fluazifop-p-butyl, haloxyfop-ethoxyethyl, haloxyfop-methyl, haloxyfop-p-methyl, isoxapyrifop, propaq uizafop, q uizalofop-ethyl, quizalofop-p-ethyl, q uizalofop-tefuryl;
phenylacetic acids, such as chlorfenac;
phenylureas, such as buturon, chlorotoluron, chlorbromuron, chloroxuron, dimefuron, diuron, fenuron, isoproturon, linuron, monolinuron, monuron, metobenzuron, metobromuron, metoxuron, neburon;
phenylpropionic acids, such as chlorophenprop-methyl;
ppi-active compounds, such as benzofenap, flumichlorac, flumiclorac-pentyl, flumioxazin, flumipropyn, flupropacil, pyrazoxyfen, sulfentrazone, thidiazimin;
pyrazoles, such as nipyraclofen;
pyridazines, such as chloridazon, maleic hydrazide, norflurazon, pyridate;
pyridinecarboxylic acids, such as clopyralid, dithiopyr, picloram, thiazopyr;
pyrimidyl ethers, such as pyrithiobac-acid, pyrithiobac-sodium, KIH-2023, KIH-6127;
sulfonamides, such as flumetsulam, metosulam;
sulfonylureas, such as amidosulfuron, azimsulfuron, bensulfuron-methyl, chlorimuron-ethyl, chlorsulfuron, cinosulfuron, cyclosulfamuron, ethoxysulfuron, ethametsulfuron-methyl, flazasulfuron, flupyrsulfuron-methyl, foramsulfuron, halosulfuron-methyl, imazosulfuron, idosulfuron, metsulfuron-methyl, nicosulfuron, oxasulfuron, primisulfuron, prosulfuron, pyrazosulfuron-ethyl, rimsulfuron, sulfometuron-methyl, sulfosulfuron, thifensulfuron-methyl, triasulfuron, tribenuron-methyl, triflusulfuron-methyl, tritosulfuron;
thiadiazolylureas, such as ethidimuron, tebuthiuron, thiazafluron;
triazines, such as ametryn, atrazine, atraton, cyanazine, cyprazine, desmetryn, dipropetryn, isomethiozin, propazine, promethryn, prometon, sebuthylazine, secbumethon, simazine, tebutryn, terbumeton, terbuthylazine, trietazine;
triazolecarboxamides, such as triazofenamide;
uracils, such as bromacil, butafenacil, lenacil, terbacil;
furthermore azafenidin, aziprotryne, bromuron, benazolin, benfuresate, bensulide, benzofluor, bentazon, bromofenoxim, butamifos, cafenstrole, chlorthal-dimethyl, cinmethylin, cinidon-ethyl, defenuron, dichlobenil, endothall, fluorbentranil, fluthiacet-methyl, inxynil, isoxaflutole, mefluidide, methazole, metribuzin, metramitron, perfluidone, piperophos, topramezone;
crop protection agents of the cyclohexenone type, such as alloxydim, clethodim, cloproxydim, cycloxydim, sethoxydim and tralkoxydim. Particularly preferred herbicidally active compounds of the cyclohexenone type are: tepraloxydim (cf. AGROW, No. 243,11.3.95, page 21, caloxydim) and 2-(1-[2-{4-chlorophenoxy}-propyloxyimino]butyl)-3-hydroxy-5-(2H-tetrahydrothiopyran-3-yl)-2-cyclohexen-1-one, and a particularly preferred herbicidally active compound of the sulfonylurea type is: N-(((4-methoxy-6-[trifluoromethyl]-1,3,5-triazin-2-yl)amino)carbonyl)-2-(trifluoromethyl)benzenesulfonamide.

Fungicides include, for instance, aliphatic nitrogen fungicides, such as butylamine, cymoxanil, dodicin, dodine, guazatine, iminoctadine; amide fungicides, such as carpropamid, chloraniformethan, cyflufenamid, diclocymet, ethaboxam, fenoxanil, flumetover, furametpyr, mandipropamid, penthiopyrad, prochloraz, quinazamid, silthiofam, triforine; especially acylamino acid fungicides, such as benalaxyl, benalaxyl-M, furalaxyl, metalaxyl, metalaxyl-M, pefurazoate; anilide fungicides, such as benalaxyl, benalaxyl-M, boscalid, carboxin, fenhexamid, metalaxyl, metalaxyl-M, metsulfovax, ofurace, oxadixyl, oxycarboxin, pyracarbolid, thifluzamide, tiadinil; in particular benzanilide fungicides, such as benodanil, flutolanil, mebenil, mepronil, salicylanilide, tecloftalam; furanilide fungicides, such as fenfuram, furalaxyl, furcarbanil, methfuroxam; and sulfonanilide fungicides, such as flusulfamide; benzamide fungicides, such as benzohydroxamic acid, fluopicolide, tioxymid, trichlamide, zarilamid, zoxamide; furamide fungicides, such as cyclafuramid, furmecyclox; phenylsulfamide fungicides, such as dichlofluanid, tolylfluanid; sulfonamide fungicides, such as cyazofamid; and valinamide fungicides, such as benthiavalicarb, iprovalicarb; antibiotic fungicides, such as aureofungin, blasticidin-S, cycloheximide, griseofulvin, kasugamycin, natamycin, polyoxins, polyoxorim, streptomycin, validamycin; especially strobilurin fungicides, such as azoxystrobin, dimoxystrobin, fluoxastrobin, kresoxim-methyl, metominostrobin, orysastrobin, picoxystrobin, pyraclostrobin, trifloxystrobin; aromatic fungicides, such as biphenyl, chlorodinitronaphthalene, chloroneb, chlorothalonil, cresol, dicloran, hexachlorobenzene, pentachlorophenol, quintozene, sodium pentachlorophenoxide, tecnazene; benzimidazole fungicides, such as benomyl, carbendazim, chlorfenazole, cypendazole, debacarb, fuberidazole, mecarbinzid, rabenzazole, thiabendazole; benzimidazole precursor fungicides, such as furophanate, thiophanate, thiophanate-methyl; benzothiazole fungicides, such as bentaluron, chlobenthiazone, TCMTB; bridged diphenyl fungicides, such as bithionol, dichlorophen, diphenylamine; carbamate fungicides, such as benthiavalicarb, furophanate, iprovalicarb, propamocarb, thiophanate, thiophanate-methyl; especially benzimidazolylcarbamate fungicides, such as benomyl, carbendazim, cypendazole, debacarb, mecarbinzid; and carbanilate fungicides, such as diethofencarb; conazole fungicides; especially conazole fungicides (imidazoles), such as climbazole, clotrimazole, imazalil, oxpoconazole, prochloraz, triflumizole; and conazole fungicides (triazoles), such as azaconazole, bromuconazole, cyproconazole, diclobutrazol, difenoconazole, diniconazole, diniconazole-M, epoxiconazole, etaconazole, fenbuconazole, fluquinconazole, flusilazole, flutriafol, furconazole, furconazole-cis, hexaconazole, imibenconazole, ipconazole, metconazole, myclobutanil, penconazole, propiconazole, prothioconazole, quinconazole, simeconazole, tebuconazole, tetraconazole, triadimefon, triadimenol, triticonazole, uniconazole, uniconazole-P; copper fungicides, such as Bordeaux mixture, Burgundy mixture, Cheshunt mixture, copper acetate, copper carbonate, basic, copper hydroxide, copper naphthenate, copper oleate, copper oxychloride, copper sulfate, copper sulfate, basic, copper zinc chromate, cufraneb, cuprobam, cuprous oxide, mancopper, oxine copper; dicarboximide fungicides, such as famoxadone, fluoroimide; especially dichlorophenyl dicarboximide fungicides, such as chlozolinate, dichlozoline, iprodione, isovaledione, myclozolin, procymidone, vinclozolin; and phthalimide fungicides, such as captafol, captan, ditalimfos, folpet, thiochlorfenphim; dinitrophenol fungicides, such as binapacryl, dinobuton, dinocap, dinocap-4, dinocap-6, dinocton, dinopenton, dinosulfon, dinoterbon, DNOC; dithiocarbamate fungicides, such as azithiram, carbamorph, cufraneb, cuprobam, disulfiram, ferbam, metam, nabam, tecoram, thiram, ziram; especially cyclic dithiocarbamate fungicides, such as dazomet, etem, milneb; and polymeric dithiocarbamate fungicides, such as mancopper, mancozeb, maneb, metiram, polycarbamate, propineb, zineb; imidazole fungicides, such as cyazofamid, fenamidone, fenapanil, glyodin, iprodione, isovaledione, pefurazoate, triazoxide; inorganic fungicides, such as potassium azide, potassium thiocyanate, sodium azide, sulfur; mercury fungicides; especially inorganic mercury fungicides, such as mercuric chloride, mercuric oxide, mercurous chloride; and organomercury fungicides, such as (3-ethoxypropyl)mercury bromide, ethylmercury acetate, ethylmercury bromide, ethylmercury chloride, ethylmercury 2,3-dihydroxypropyl mercaptide, ethylmercury phosphate, N-(ethylmercury)-p-toluenesulphonanilide, hydrargaphen, 2-methoxyethylmercury chloride, methylmercury benzoate, methylmercury dicyandiamide, methylmercury pentachlorophenoxide, 8-phenylmercurioxyquinoline, phenylmercuriurea, phenylmercury acetate, phenylmercury chloride, phenylmercury derivative of pyrocatechol, phenylmercury nitrate, phenylmercury salicylate, thiomersal, tolylmercury acetate; morpholine fungicides, such as aldimorph, benzamorf, carbamorph, dimethomorph, dodemorph, fenpropimorph, flumorph, tridemorph; organophosphorus fungicides, such as ampropylfos, ditalimfos, edifenphos, fosetyl, hexylthiofos, iprobenfos, phosdiphen, pyrazophos, tolclofos-methyl, triamiphos; organotin fungicides, such as decafentin, fentin, tributyltin oxide; oxathiin fungicides, such as carboxin, oxycarboxin; oxazole fungicides, such as chlozolinate, dichlozoline, drazoxolon, famoxadone, hymexazol, metazoxolon, myclozolin, oxadixyl, vinclozolin; polysulfide fungicides, such as barium polysulfide, calcium polysulfide, potassium polysulfide, sodium polysulfide; pyrazole fungicides, such as furametpyr, penthiopyrad; pyridine fungicides, such as boscalid, buthiobate, dipyrithione, fluazinam, fluopicolide, pyridinitril, pyrifenox, pyroxychlor, pyroxyfur; pyrimidine fungicides, such as bupirimate, cyprodinil, diflumetorim, dimethirimol, ethirimol, fenarimol, ferimzone, mepanipyrim, nuarimol, pyrimethanil, triarimol; pyrrole fungicides, such as fenpiclonil, fludioxonil, fluoroimide; quinoline fungicides, such as ethoxyquin, halacrinate, 8-hydroxyquinoline sulfate, quinacetol, quinoxyfen; quinone fungicides, such as benquinox, chloranil, dichlone, dithianon; quinoxaline fungicides, such as chinomethionat, chlorquinox, thioquinox; thiazole fungicides, such as ethaboxam, etridiazole, metsulfovax, octhilinone, thiabendazole, thiadifluor, thifluzamide; thiocarbamate fungicides, such as methasulfocarb, prothiocarb; thiophene fungicides, such as ethaboxam, silthiofam; triazine fungicides, such as anilazine; triazole fungicides, such as bitertanol, fluotrimazole, triazbutil; urea fungicides, such as bentaluron, pencycuron, quinazamid; unclassified fungicides, such as acibenzolar, acypetacs, allyl alcohol, benzalkonium chloride, benzamacril, bethoxazin, carvone, chloropicrin, DBCP, dehydroacetic acid, diclomezine, diethyl pyrocarbonate, fenaminosulf, fenitropan, fenpropidin, formaldehyde, furfural, hexachlorobutadiene, iodomethane, isoprothiolane, methyl bromide, methyl isothiocyanate, metrafenone, nitrostyrene, nitrothal-isopropyl, OCH, 2-phenylphenol, phthalide, piperalin, probenazole, proquinazid, pyroquilon, sodium orthophenylphenoxide, spiroxamine, sultropen, thicyofen, tricyclazole, zinc naphthenate.

According to a particular embodiment of the present invention, fungicides include:
acylalanines, such as benalaxyl, metalaxyl, ofurace, oxadixyl;
amine derivatives, such as aldimorph, dodine, dodemorph, fenpropimorph, fenpropidin, guazatine, iminoctadine, spiroxamine, tridemorph;
anilinopyrimidines, such as pyrimethanil, mepanipyrim or cyprodinil;
antibiotics, such as cycloheximide, griseofulvin, kasugamycin, natamycin, polyoxin and streptomycin;
azoles: azaconazole, bitertanol, bromoconazole, cyproconazole, dichlobutrazole, difenoconazole, dinitroconazole, epoxiconazole, fenbuconazole, fluquinconazole, flusilazole, flutriafol, ketoconazole, hexaconazole, metconazole, myclobutanil, penconazole, propiconazole, prothioconazole, tebuconazole, tetraconazole, triadimefon, triadimenol, triflumizole, triticonazole;
dicarboximides, such as iprodione, myclozolin, procymidone, vinclozolin;
dithiocarbamates: ferbam, nabam, maneb, mancozeb, metam, metiram, propineb, polycarbamate, thiram, ziram, zineb;
heterocyclic compounds, such as anilazine, benomyl, boscalid, carbendazim, carboxin, oxycarboxin, cyazofamid, dazomet, dithianon, famoxadone, fenamidone, fenarimol, fuberidazole, flutolanil, furametpyr, isoprothiolane, mepronil, nuarimol, probenazole, proquinazid, pyrifenox, pyroquilon, quinoxyfen, silthiofam, thiabendazole, thifluzamide, thiophenate-methyl, tiadinil, tricyclazole, triforine;
nitrophenyl derivatives, such as binapacryl, dinocap, dinobuton, nitrophthal-isopropyl;
phenylpyrroles, such as fenpiclonil and also fludioxonil;
2-methoxybenzophenones as described in EP-A 897904 by the general formula I, for example metrafenone;
fungicides not belonging to any of the other classes, such as acibenzolar-S-methyl, benthiavalicarb, carpropamid, chlorothalonil, cyflufenamid, cymoxanil, diclomezine, diclocymet, diethofencarb, edifenphos, ethaboxam, fenhexamid, fentin-acetate, fenoxanil, ferimzone, fluazinam, fosetyl, foestyl-aluminum, iprovalicarb, hexachlorobenzol, metrafenone, pencycuron, propamocarb, phthalide, toloclofos-methyl, quintozene, zoxamide;
strobilurins as described in WO 03/075663 by the general formula I, for example: azoxystrobin, dimoxystrobin, fluoxastrobin, kresoxim-methyl, metominostrobin, orysastrobin, picoxystrobin, pyraclostrobin and trifloxystrobin;
sulfenic acid derivatives, such as captafol, captan, dichlofluanid, folpet, tolylfluanid;
cinnamides and analogs thereof, such as dimethomorph, flumetover, flumorph;
6-aryl-[1,2,4]triazolo[1,5-a]pyrimidines as described, for example, in WO 98/46608, WO 99/41255 or WO 03/004465 in each case by the general formula I, for example 5-chloro-7-(4-methylpiperidin-1-yl)-6-(2,4,6-trifluorophenyl)-[1,2,4]triazolo(1,5-a]pyrimidine, 5-chloro-7-(4-methylpiperazin-1-yl)-6-(2,4,6-trifluorophenyl)-[1,2,4]triazolo[1,5-a]pyrimidine, 5-chloro-7-(morpholin-1-yl)-6-(2,4,6-trifluorophenyl)-[1,2,4]triazolo[1,5-a]pyrimidine, 5-chloro-7-(piperidin-1-yl)-6-(2,4,6-trifluorophenyl)-[1,2,4]triazolo[1,5-a]pyrimidine, 5-chloro-7-(morpholin-1-yl)-6-(2,4,6-trifluorophenyl)-[1,2,4]triazolo[1,5-a]pyrimidine, 5-chloro-7-(isopropylamino)-6-(2,4,6-trifluorophenyl)-[1,2,4]triazolo[1,5-a]pyrimidine, 5-chloro-7-(cyclopentylamino)-6-(2,4,6-trifluorophenyl)-[1,2,4]triazolo[1,5-a]pyrimidine, 5-chloro-7-(2,2,2-trifluoroethylamino)-6-(2,4,6-trifluorophenyl)-[1,2,4]triazolo[1,5-a]pyrimidine, 5-chloro-7-(1,1,1-trifluoropropan-2-ylamino)-6-(2,4,6-trifluorophenyl)-[1,2,4]triazolo[1,5-a]pyrimidine, 5-chloro-7-(3,3-dimethylbutan-2-ylamino)-6-(2,4,6-trifluorophenyl)-[1,2,4]triazolo[1,5-a]pyrimidine, 5-chloro-7-(cyclohexylmethyl)-6-(2,4,6-trifluorophenyl)-[1,2,4]triazolo[1,5-a]pyrimidine, 5-chloro-7-(cyclohexyl)-6-(2,4,6-trifluorophenyl)-[1,2,4]triazolo[1,5-a]pyrimidine, 5-chloro-7-(2-methylbutan-3-yl)-6-(2,4,6-trifluorophenyl)-[1,2,4]triazolo[1,5-a]pyrimidine, 5-chloro-7-(3-methylpropan-1-yl)-6-(2,4,6-trifluorophenyl)-[1,2,4]triazolo[1,5-a]pyrimidine, 5-chloro-7-(4-methylcyclohexan-1-yl)-6-(2,4,6-trifluorophenyl)-[1,2,4]triazolo[1,5-a]pyrimidine, 5-chloro-7-(hexan-3-yl)-6-(2,4,6-trifluorophenyl)-[1,2,4]triazolo[1,5-a]pyrimidine, 5-chloro-7-(2-methylbutan-1-yl)-6-(2,4,6-trifluorophenyl)-[1,2,4]triazolo[1,5-a]pyrimidine, 5-chloro-7-(3-methylbutan-1-yl)-6-(2,4,6-trifluorophenyl)-[1,2,4]triazolo[1,5-a]pyrimidine, 5-chloro-7-( 1-methylpropan-1-yl)-6-(2,4,6-trifluorophenyl)-[1,2,4]triazolo[1,5-a]pyrimidine, 5-methyl-7-(4-methylpiperidin-1-yl)-6-(2,4,6-trifluorophenyl)-[1,2,4]triazolo[1,5-a]pyrimidine, 5-methyl-7-(4-methylpiperazin-1-yl)-6-(2,4,6-trifluorophenyl)-[1,2,4]triazolo[1,5-a]pyrimidine, 5-methyl-7-(morpholin-1-yl)-6-(2,4,6-trifluorophenyl)-[1,2,4]triazolo[1,5-a]pyrimidine, 5-methyl-7-(piperidin-1-yl)-6-(2,4,6-trifluorophenyl)-[1,2,4]triazolo[1,5-a]pyrimidine, 5-methyl-7-(morpholin-1-yl)-6-(2,4,6-trifluorophenyl)-[1,2,4]triazolo[1,5-a]pyrimidine, 5-methyl-7-(isopropylamino)-6-(2,4,6-trifluorophenyl)-[1,2,4]triazolo[1,5-a]pyrimidine, 5-methyl-7-(cyclopentylamino)-6-(2,4,6-trifluorophenyl)-[1,2,4]triazolo[1,5-a]pyrimidine, 5-methyl-7-(2,2,2-trifluorethylamino)-6-(2,4,6-trifluorophenyl)-[1,2,4]triazolo[1,5-a]pyrimidine, 5-methyl-7-(1,1,1-trifluoropropan-2-ylamino)-6-(2,4,6-trifluorophenyl)-[1,2,4]triazolo[1,5-a]pyrimidine, 5-methyl-7-(3,3-dimethylbutan-2-ylamino)-6-(2,4,6-trifluorophenyl)-[1,2,4]triazolo[1,5-a]pyrimidine, 5-methyl-7-(cyclohexylmethyl)-6-(2,4,6-trifluorophenyl)-[1,2,4]triazolo[1,5-a]pyrimidine, 5-methyl-7-(cyclohexyl)-6-(2,4,6-trifluorophenyl)-[1,2,4]triazolo[1,5-a]pyrimidine, 5-methyl-7-(2-methylbutan-3-yl)-6-(2,4,6-trifluorophenyl)-[1,2,4]triazolo[1,5-a]pyrimidine, 5-methyl-7-(3-methylpropan-1-yl)-6-(2,4,6-trifluorophenyl)-[1,2,4]triazolo[1,5-a]pyrimidine, 5-methyl-7-(4-methylcyclohexan-1-yl)-6-(2,4,6-trifluorophenyl)-[1,2,4]triazolo[1,5-a]pyrimidine, 5-methyl-7-(hexan-3-yl)-6-(2,4,6-trifluorophenyl)-[1,2,4]triazolo[1,5-a]pyrimidine, 5-methyl-7-(2-methylbutan-1-yl)-6-(2,4,6-trifluorophenyl)-[1,2,4]triazolo[1,5-a]pyrimidine, 5-methyl-7-(3-methylbutan-1-yl)-6-(2,4,6-trifluorophenyl)-[1,2,4]triazolo[1,5-a]pyrimidine and 5-methyl-7-(1-methylpropan-1-yl)-6-(2,4,6-trifluorophenyl)-[1,2,4]triazolo[1,5-a]pyrimidine;
amide fungicides, such as cyclofenamid, and also (Z)-N-[α-(cyclopropylmethoxy-imino)-2,3-difluoro-6-(difluoromethoxy)benzyl]-2-phenylacetamide.

Insecticides include, for instance antibiotic insecticides, such as allosamidin, thuringiensin; especially macrocyclic lactone insecticides, such as spinosad; in particular avermectin insecticides, such as abamectin, doramectin, emamectin, eprinomectin, ivermectin, selamectin; and milbemycin insecticides, such as lepimectin, milbemectin, milbemycin oxime, moxidectin; arsenical insecticides, such as calcium arsenate, copper acetoarsenite, copper arsenate, lead arsenate, potassium arsenite, sodium arsenite; botanical insecticides, such as anabasine, azadirachtin, d-limonene, nicotine, pyrethrins, cinerins, cinerin I, cinerin II, jasmolin I, jasmolin II, pyrethrin I, pyrethrin II, quassia, rotenone, ryania, sabadilla; carbamate insecticides, such as bendiocarb, carbaryl; especially benzofuranyl methylcarbamate insecticides, such as benfuracarb, carbofuran, carbosulfan, decarbofuran, furathiocarb; dimethylcarbamate insecticides, such as dimetan, dimetilan, hyquincarb, pirimicarb; oxime carbamate insecticides, such as alanycarb, aldicarb, aldoxycarb, butocarboxim, butoxycarboxim, methomyl, nitrilacarb, oxamyl, tazimcarb, thiocarboxime, thiodicarb, thiofanox; and phenyl methylcarbamate insecticides, such as allyxycarb, aminocarb, bufencarb, butacarb, carbanolate, cloethocarb, dicresyl, dioxacarb, EMPC, ethiofencarb, fenethacarb, fenobucarb, isoprocarb, methiocarb, metolcarb, mexacarbate, promacyl, promecarb, propoxur, trimethacarb, XMC, xylylcarb; dinitrophenol insecticides, such as dinex, dinoprop, dinosam, DNOC; fluorine insecticides, such as barium hexafluorosilicate, cryolite, sodium fluoride, sodium hexafluorosilicate, sulfluramid; formamidine insecticides, such as amitraz, chlordimeform, formetanate, formparanate; fumigant insecticides, such as acrylonitrile, carbon disulfide, carbon tetrachloride, chloroform, chloropicrin, para-dichlorobenzene, 1,2-dichloropropane, ethyl formate, ethylene dibromide, ethylene dichloride, ethylene oxide, hydrogen cyanide, iodomethane, methyl bromide, methylchloroform, methylene chloride, naphthalene, phosphine, sulfuryl fluoride, tetrachloroethane; inorganic insecticides, such as borax, calcium polysulfide, copper oleate, mercurous chloride, potassium thiocyanate, sodium thiocyanate; insect growth regulators; especially chitin synthesis inhibitors, such as bistrifluron, buprofezin, chlorfluazuron, cyromazine, diflubenzuron, flucycloxuron, flufenoxuron, hexaflumuron, lufenuron, novaluron, noviflumuron, penfluron, teflubenzuron, triflumuron; juvenile hormone mimics, such as epofenonane, fenoxycarb, hydroprene, kinoprene, methoprene, pyriproxyfen, triprene; juvenile hormones, such as juvenile hormone I, juvenile hormone II, juvenile hormone III; moulting hormone agonists, such as chromafenozide, halofenozide, methoxyfenozide, tebufenozide; moulting hormones, such as α-ecdysone, ecdysterone; moulting inhibitors, such as diofenolan; precocenes, such as precocene I, precocene II, precocene III; and unclassified insect growth regulators, such as dicyclanil; nereistoxin analogue insecticides, such as bensultap, cartap, thiocyclam, thiosultap; nicotinoid insecticides, such as flonicamid; especially nitroguanidine insecticides, such as clothianidin, dinotefuran, imidacloprid, thiamethoxam; nitromethylene insecticides, such as nitenpyram, nithiazine; and pyridylmethylamine insecticides, such as acetamiprid, imidacloprid, nitenpyram, thiacloprid; organochlorine insecticides, such as bromo-DDT, camphechlor, DDT, pp′-DDT, ethyl-DDD, HCH, gamma-HCH, lindane, methoxychlor, pentachlorophenol, TDE; especially cyclodiene insecticides, such as aldrin, bromocyclen, chlorbicyclen, chlordane, chlordecone, dieldrin, dilor, endosulfan, endrin, HEOD, heptachlor, HHDN, isobenzan, isodrin, kelevan, mirex; organophosphorus insecticides; especially organophosphate insecticides, such as bromfenvinfos, chlorfenvinphos, crotoxyphos, dichlorvos, dicrotophos, dimethylvinphos, fospirate, heptenophos, methocrotophos, mevinphos, monocrotophos, naled, naftalofos, phosphamidon, propaphos, TEPP, tetrachlorvinphos; organothiophosphate insecticides, such as dioxabenzofos, fosmethilan, phenthoate; in particular aliphatic organothiophosphate insecticides, such as acethion, amiton, cadusafos, chlorethoxyfos, chlormephos, demephion, demephion-O, demephion-S, demeton, demeton-O, demeton-S, demeton-methyl, demeton-O-methyl, demeton-S-methyl, demeton-S-methylsulphon, disulfoton, ethion, ethoprophos, IPSP, isothioate, malathion, methacrifos, oxydemeton-methyl, oxydeprofos, oxydisulfoton, phorate, sulfotep, terbufos, thiometon; more particularly aliphatic amide organothiophosphate insecticides, such as amidithion, cyanthoate, dimethoate, ethoate-methyl, formothion, mecarbam, omethoate, prothoate, sophamide, vamidothion; and oxime organothiophosphate insecticides, such as chlorphoxim, phoxim, phoxim-methyl; heterocyclic organothiophosphate insecticides, such as azamethiphos, coumaphos, coumithoate, dioxathion, endothion, menazon, morphothion, phosalone, pyraclofos, pyridaphenthion, quinothion; more particularly benzothiopyran organothiophosphate insecticides, such as dithicrofos, thicrofos; benzotriazine organothiophosphate insecticides, such as azinphos-ethyl, azinphos-methyl; isoindole organothiophosphate insecticides, such as dialifos, phosmet; isoxazole organothiophosphate insecticides, such as isoxathion, zolaprofos; pyrazolopyrimidine organothiophosphate insecticides, such as chlorprazophos, pyrazophos; pyridine organothiophosphate insecticides, such as chlorpyrifos, chlorpyrifos-methyl; pyrimidine organothiophosphate insecticides, such as butathiofos, diazinon, etrimfos, lirimfos, pirimiphos-ethyl, pirimiphos-methyl, primidophos, pyrimitate, tebupirimfos; quinoxaline organothiophosphate insecticides, such as quinalphos, quinalphos-methyl; thiadiazole organothiophosphate insecticides, such as athidathion, lythidathion, methidathion, prothidathion; and triazole organothiophosphate insecticides, such as isazofos, triazophos; and phenyl organothiophosphate insecticides, such as azothoate, bromophos, bromophos-ethyl, carbophenothion, chlorthiophos, cyanophos, cythioate, dicapthon, dichlofenthion, etaphos, famphur, fenchlorphos, fenitrothion, fensulfothion, fenthion, fenthion-ethyl, heterophos, jodfenphos, mesulfenfos, parathion, parathion-methyl, phenkapton, phosnichlor, profenofos, prothiofos, sulprofos, temephos, trichlormetaphos-3, trifenofos; phosphonate insecticides, such as butonate, trichlorfon; phosphonothioate insecticides, such as mecarphon; in particular phenyl ethylphosphonothioate insecticides, such as fonofos, trichloronat; and phenyl phenylphosphonothioate insecticides, such as cyanofenphos, EPN, leptophos; phosphoramidate insecticides, such as crufomate, fenamiphos, fosthietan, mephosfolan, phosfolan, pirimetaphos; phosphoramidothioate insecticides, such as acephate, isocarbophos, isofenphos, methamidophos, propetamphos; and phosphorodiamide insecticides, such as dimefox, mazidox, mipafox, schradan; oxadiazine insecticides, such as indoxacarb; phthalimide insecticides, such as dialifos, phosmet, tetramethrin; pyrazole insecticides, such as acetoprole, ethiprole, fipronil, pyrafluprole, pyriprole, tebufenpyrad, tolfenpyrad, vaniliprole; pyrethroid insecticides; especially pyrethroid ester insecticides, such as acrinathrin, allethrin, bioallethrin, barthrin, bifenthrin, bioethanomethrin, cyclethrin, cycloprothrin, cyfluthrin, beta-cyfluthrin, cyhalothrin, gamma-cyhalothrin, lambda-cyhalothrin, cypermethrin, alpha-cypermethrin, beta-cypermethrin, theta-cypermethrin, zeta-cypermethrin, cyphenothrin, deltamethrin, dimefluthrin, dimethrin, empenthrin, fenfluthrin, fenpirithrin, fenpropathrin, fenvalerate, esfenvalerate, flucythrinate, fluvalinate, tau-fluvalinate, furethrin, imiprothrin, metofluthrin, permethrin, biopermethrin, transpermethrin, phenothrin, prallethrin, profluthrin, pyresmethrin, resmethrin, bioresmethrin, cismethrin, tefluthrin, terallethrin, tetramethrin, tralomethrin, transfluthrin; and pyrethroid ether insecticides, such as etofenprox, flufenprox, halfenprox, protrifenbute, silafluofen; pyrimidinamine insecticides, such as flufenerim, pyrimidifen; pyrrole insecticides, such as chlorfenapyr; tetronic acid insecticides, such as spiromesifen; thiourea insecticides, such as diafenthiuron; urea insecticides, such as flucofuron, sulcofuron; unclassified insecticides, such as closantel, crotamiton, EXD, fenazaflor, fenoxacrim, flubendiamide, hydramethylnon, isoprothiolane, malonoben, metaflumizone, metoxadiazone, nifluridide, pyridaben, pyridalyl, rafoxanide, triarathene, triazamate.

According to a particular embodiment of the present invention, insecticides include:
organophosphates, such as azinphos-methyl, azinphos-ethyl, chlorpyrifos, chlorpyrifos-methyl, chlorfenvinphos, diazinon, dimethylvinphos, dioxabenzofos, disulfoton, ethion, EPN, fenitrothion, fenthion, heptenophos, isoxathion, malathion, methidathion, methyl-parathion, paraoxon, parathion, phenthoate, phosalone, phosmet, phorate, phoxim, pirimiphos-methyl, profenofos, prothiofos, primiphos-ethyl, pyraclofos, pyridaphenthion, sulprofos, triazophos, trichlorfon, tetrachlorvinphos, vamidothion;
carbamates, such as alanycarb, benfuracarb, bendiocarb, carbaryl, carbofuran, carbosulfan, fenoxycarb, furathiocarb, indoxacarb, methiocarb, pirimicarb, propoxur, thiodicarb, triazamate;
pyrethroids, such as bifenthrin, cyfluthrin, cycloprothrin, cypermethrin, deltamethrin, esfenvalerate, ethofenprox, fenpropathrin, fenvalerate, cyhalothrin, lambda-cyhalothrin, permethrin, silafluofen, tau-fluvalinate, tefluthrin, tralomethrin, alpha-cypermethrin, permethrin;
arthropod growth regulators: a) chitin synthesis inhibitors, for example benzoylureas, such as chlorfluazuron, diflubenzuron, flucycloxuron, flufenoxuron, hexaflumuron, lufenuron, novaluron, teflubenzuron, triflumuron; buprofezin, diofenolan, hexythiazox, etoxazole, clofentazine; b) ecdysone antagonists, such as halofenozide, methoxyfenozide, tebufenozide; c) juvenoids, such as pyriproxyfen, methoprene; d) lipid biosynthesis inhibitors, such as spirodiclofen;
neonicotinoids, such as flonicamid, clothianidin, dinotefuran, imidacloprid, thiamethoxam, nithiazine, acetamiprid, thiacloprid;
further insecticides which do not belong to the above classes, such as abamectin, acequinocyl, acetamiprid, amitraz, azadirachtin, bensultap, bifenazate, cartap, chlorfenapyr, chlordimeform, diafenthiuron, dinetofuran, diofenolan, emamectin, endosulfan, ethiprole, fenazaquin, fipronil, formetanate, formetanate hydrochloride, gamma-HCH, hydramethyinon, imidacloprid, indoxacarb, isoprocarb, metolcarb, pyridaben, pymetrozine, spinosad, tebufenpyrad, thiamethoxam, XMC and xylylcarb and
N-phenylsemicarbazones as described in EP-A 462 456 by the formula I, in particular compounds of the general formula IV

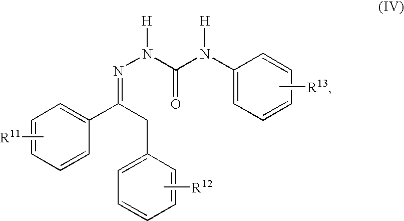

in which R¹¹ and R¹² independently of one another are hydrogen, halogen, CN, C₁-C₄-alkyl, C₁-C₄-alkoxy, C₁-C₄-haloalkyl or C₁-C₄-haloalkoxy and R¹³ is C₁-C₄-alkoxy, C₁-C₄-haloalkyl or C₁-C₄-haloalkoxy, for example compounds IV in which R¹¹ is 3-CF₃ and R¹² is 4-CN and R¹³ is 4-OCF₃;

According to a particular aspect of the invention, the pesticide can be a neutral or ionic (anionic or cationic) compound, an acidic or basic compound, optionally in the form an acid or base addition salt, a polar or apolar compound.

Particular pesticides are selected from the group consisting of phenoxyacetic herbicides and plant growth regulators such as (2,4-dichlorophenoxy)acetic acid; nitrophenyl ether herbicides such as 5-(2-chloro-α,α,α-trifluoro-p-tolyloxy)-2-nitrobenzoic acid; pyrethroid ester acaricides and insecticides such as the racemate comprising (R)-α-cyano-3-phenoxybenzyl (1S,3S)-3-(2,2-dichlorovinyl)-2,2-dimethylcyclopropanecarboxylate and (S)-α-cyano-3-phenoxybenzyl (1R,3R)-3-(2,2-dichlorovinyl)-2,2-dimethylcyclopropanecarboxylate, the racemate comprising (R)-α-cyano-3-phenoxybenzyl (1S)-cis-3-(2,2-dichlorovinyl)-2,2-dimethylcyclopropanecarboxylate and (S)-α-cyano-3-phenoxybenzyl (1R)-cis-3-(2,2-dichlorovinyl)-2,2-dimethylcyclopropane carboxylate; further herbicides such as 3-isopropyl-1H-2,1,3-benzothiadiazin-4(3H)-one 2,2-dioxide; anilide fungicides and pyridine fungicides such as 2-chloro-N-(4′-chlorobiphenyl-2-yl)nicotinamide; benzimidazole fungicides and benzimidazolylcarbamate fungicides such as methyl benzimidazol-2-ylcarbamate; pyrrole acaricides and insecticides such as 4-bromo-2-(4-chlorophenyl)-1-ethoxymethyl-5-(trifluoromethyl)pyrrole-3-carbonitrile; organophosphate acaricides and insecticides such as (EZ)-2-chloro-1-(2,4-dichloro phenyl)vinyl diethyl phosphate; pyridazinone herbicides such as 5-amino-4-chloro-2-phenylpyridazin-3(2H)-one; plant growth regulators such as 2-chloroethyl trimethylammonium; dicarboximide herbicides such as ethyl (Z)-2-chloro-3-[2-chloro-5-(cyclohex-1-ene-1,2-dicarboximido)phenyl]acrylate; herbicides such as (1RS,2SR,4SR)-1,4-epoxy-p-menth-2-yl 2-methylbenzyl ether; bird repellents and copper fungicides such as dicopper chloride trihydroxide; chlorotriazine herbicides such as 2-(4-chloro-6-ethylamino-1,3,5-triazin-2-ylamino)-2-methylpropionitrile; pyrimidinylsulfonylurea herbicides such as 1-[2-(cyclopropylcarbonyl)anilinosulfonyl]-3-(4,6-dimethoxypyrimidin-2-yl)urea; cyclohexene oxime herbicides such as (RS)-(EZ)-2-[1-(ethoxyimino)butyl]-3-hydroxy-5-thian-3-ylcyclohex-2-en-1-one; cyclic dithiocarbamate fungicides, dithiocarbamate herbicides and nematicides such as 3,5-dimethyl-1,3,5-thiadiazinane-2-thione, tetrahydro-3,5-dimethyl-1,3,5-thiadiazine-2-thione; benzoic acid herbicides and plant growth regulators such as 3,6-dichloro-o-anisic acid; phenoxypropionic herbicides and plant growth regulators such as (RS)-2-(2,4-dichlorophenoxy)propionic acid; quaternary ammonium herbicides such as 1,2-dimethyl-3,5-diphenylpyrazolium; urea herbicides such as 2-{1-[4-(3,5-difluoro phenyl)semicarbazono]ethyl}nicotinic acid; amide herbicides such as (S)-2-chloro-N-(2,4-dimethyl-3-thienyl)-N-(2-methoxy-1-methylethyl) acetamide; organothiophosphate acaricides, aliphatic amide organothiophosphate insecticides and nematicides such as O,O-dimethyl S-methylcarbamoylmethyl phosphoro dithioate, 2-dimethoxyphosphinothioylthio-N-methylacetamide; morpholine fungicides such as (EZ)-4-[3-(4-chlorophenyl)-3-(3,4-dimethoxyphenyl)acryloyl]morpholine; strobilurin fungicides such as (E)-2-(methoxyimino)-N-methyl-2-[α-(2,5-xylyloxy)-o-tolyl]acetamide; quinone fungicides such as 5,10-dihydro-5,10-dioxonaphtho[2,3-b]-1,4-dithi-in-2,3-dicarbonitrile; morpholine fungicides such as 4-cyclododecyl-2,6-dimethylmorpholine; conazole fungicides such as (2RS,3SR)-1-[3-(2-chlorophenyl)-2,3-epoxy-2-(4-fluorophenyl)propyl]-1H-1,2,4-triazole; pyrazole insecticides such as 5-amino-1-(2,6-dichloro-α,α,α-trifluoro-p-tolyl)-4-ethylsulfinylpyrazole-3-carbonitrile; organotin acaricides such as bis[tris(2-methyl-2-phenylpropyl)tin]oxide; amide fungicides such as a mixture of 85% (R)—N-[(RS)-1-cyano-1,2-dimethylpropyl]-2-(2,4-dichlorophenoxy)propionamide and 15% (S)—N-[(RS)-1-cyano-1,2-dimethylpropyl]-2-(2,4-dichlorophenoxy)propionamide; morpholine fungicides such as (RS)-cis-4-[3-(4-tert-butylphenyl)-2-methylpropyl]-2,6-dimethylmorpholine; pyrazole acaricides and insecticides such as 5-amino-1-(2,6-dichloro-α,α,α-trifluoro-p-tolyl)-4-trifluoromethylsulfinylpyrazole-3-carbonitrile; arylalanine herbicides such as N-benzoyl-N-(3-chloro-4-fluorophenyl)-D-alanine; coumarin rodenticides such as 4-hydroxy-3-[1,2,3,4-tetrahydro-3-[4-(4-trifluoromethylbenzyloxy)phenyl]-1-naphthyl]coumarin (e.g. mixture of cis- to trans-isomers in the ratio range 60:40 to 40:60); pyrethroid ester acaricides and insecticides such as (RS)-α-cyano-3-phenoxybenzyl (S)-2-(4-difluoromethoxyphenyl)-3-methylbutyrate; mite growth regulators and insecticides such as 1-[4-(2-chloro-α,α,α-trifluoro-p-tolyloxy)-2-fluorophenyl]-3-(2,6-difluorobenzoyl)urea; nitrophenyl ether herbicides such as O-[5-(2-chloro-α,α,α-trifluoro-p-tolyloxy)-2-nitrobenzoyl]glycolic acid; organophosphorus herbicides such as N-(phosphonomethyl)glycine; insecticides moulting hormone agonists such as N-tert-butyl-N′-(4-chlorobenzoyl)benzohydrazide; mite growth regulators and acaricides such as (4RS,5RS)-5-(4-chlorophenyl)-N-cyclohexyl-4-methyl-2-oxo-1,3-thiazolidine-3-carboxamide; insecticides such as 5,5-dimethylperhydropyrimidin-2-one 4-trifluoromethyl-α-(4-trifluoromethylstyryl)-cinnamylidenehydrazone; imidazolinone herbicides such as a reaction mixture of (RS)-6-(4-isopropyl-4-methyl-5-oxo-2-imidazolin-2-yl)-m-toluic acid and (RS)-2-(4-isopropyl-4-methyl-5-oxo-2-imidazolin-2-yl)-p-toluic acid; imidazolinone herbicides such as (RS)-2-(4-isopropyl-4-methyl-5-oxo-2-imidazolin-2-yl)-5-methoxymethyinicotinic acid, (RS)-2-(4-isopropyl-4-methyl-5-oxo-2-imidazolin-2-yl)-5-methylnicotinic acid, (RS)-2-(4-isopropyl-4-methyl-5-oxo-2-imidazolin-2-yl)nicotinic acid, (RS)-2-(4-isopropyl-4-methyl-5-oxo-2-imidazolin-2-yl)quinoline-3-carboxylic acid, (RS)-5-ethyl-2-(4-isopropyl-4-methyl-5-oxo-2-imidazolin-2-yl)nicotinic acid; dichlorophenyl dicarboximide fungicides and imidazole fungicides such as 3-(3,5-dichlorophenyl)-N-isopropyl-2,4-dioxoimidazolidine-1-carboxamide; strobilurin fungicides such as methyl (E)-methoxyimino[α-(o-tolyloxy)-o-tolyl]acetate; growth inhibitors such as 1,1-dimethylpiperidinium; insecticides such as (EZ)-2′-[2-(4-cyanophenyl)-1-(α,α,α-trifluoro-m-tolyl)ethylidene]-4-(trifluoromethoxy)carbanilohydrazide; dithiocarbamate fungicides, herbicides and nematicides such as methyldithiocarbamic acid; chloroacetanilide herbicides; conazole fungicides such as (1RS,5RS;1RS,5SR)-5-(4-chlorobenzyl)-2,2-dimethyl-1-(1H-1,2,4-triazol-1-ylmethyl)cyclopentanol; zinc ammoniate ethylenebis(dithiocarbamate)-poly(ethylenethiuramdisulfide); phenylurea herbicides such as 3-(4-bromophenyl)-1-methoxy-1-methylurea; phenylurea herbicides and plant growth regulators such as 3-(3-chloro-4-methoxyphenyl)-1,1-dimethylurea; fungicides such as 3′-bromo-2,3,4,6′-tetramethoxy-2′,6-dimethylbenzophenone; fungicides such as di-isopropyl 5-nitroisophthalate; strobilurin fungicides such as (2E)-2-(methoxyimino)-2-{2-[(3E,5E,6E)-5-(methoxyimino)-4,6-dimethyl-2,8-dioxa-3,7-diazanona-3,6-dien-1-yl]phenyl}-N-methylacetamide; dinitroaniline herbicides such as N-(1-ethylpropyl)-2,6-dinitro-3,4-xylidine; organothiophosphate acaricides, aliphatic amide organothio phosphate insecticides and nematicides such as O,O-diethyl S-ethylthio methyl phosphorodithioate; anilide herbicides and pyridine herbicides such as 4′-fluoro-6-(α,α,α-trifluoro-m-tolyloxy)pyridine-2-carboxanilide; amide fungicides and conazole fungicides such as N-propyl-N-[2-(2,4,6-trichloro phenoxy)ethyl]imidazole-1-carboxamide, 1-{N-propyl-N-[2-(2,4,6-trichlorophenoxy)ethyl]}carbamoylimidazole; cyclohexene oxime herbicides such as 2-{(EZ)-1-[(2RS)-2-(4-chlorophenoxy)propoxyimino]butyl)-3-hydroxy-5-(thian-3-yl)cyclohex-2-en-1-one; plant growth regulators such as 3,5-dioxo-4-propionylcyclohexanecarboxylic acid; strobilurin fungicides such as methyl N-{2-[1-(4-chlorophenyl)-1H-pyrazol-3-yloxymethyl]phenyl}(N-methoxy)carbamate; acaricides and insecticides such as 2-tert-butyl-5-(4-tert-butylbenzylthio)-4-chloropyridazin-3(2H)-one; pyrimidine fungicides such as N-(4,6-dimethylpyrimidin-2-yl)aniline; quinolinecarboxylic acid herbicides such as 3,7-dichloroquinoline-8-carboxylic acid, 7-chloro-3-methylquinoline-8-carboxylic acid; cyclohexene oxime herbicides such as (RS)-(EZ)-2-(1-ethoxyiminobutyl)-5-[2-(ethylthio)propyl]-3-hydroxycyclohex-2-en-1-one, pyrazole acaricides and insecticides such as N-(4-tert-butylbenzyl)-4-chloro-3-ethyl-1-methylpyrazole-5-carboxamide; insecticides and chitin synthesis inhibitors such as 1-(3,5-dichloro-2,4-difluorophenyl)-3-(2,6-difluorobenzoyl)urea; phenyl organothiophosphate insecticides such as O,O,O′,O′-tetramethyl O,O′-thiodi-p-phenylene bis(phosphorothioate), O,O,O′,O′-tetramethyl O,O′-thiodi-p-phenylene diphosphorothioate; cyclohexene oxime herbicides such as (RS)-(EZ)-2-{1-[(2E)-3-chloroallyloxyimino]propyl}-3-hydroxy-5-perhydropyran-4-ylcyclohex-2-en-1-one; aliphatic organothiophosphate insecticides and nematicides such as S-tert-butylthiomethyl O,O-diethyl phosphoro dithioate; benzimidazole precursor fungicides and carbamate fungicides such as dimethyl 4,4′-(o-phenylene)bis(3-thioallophanate); phenyl pyrazolyl ketone herbicides such as [3-(4,5-dihydro-1,2-oxazol-3-yl)-4-mesyl-o-tolyl](5-hydroxy-1-methyl-1H-pyrazol-4-yl)methanone; insecticides such as ethyl(3-tert-butyl-1-dimethylcarbamoyl-1H-1,2,4-triazol-5-ylthio)acetate; morpholine fungicides such as a reaction mixture of 4-alkyl-2,6-dimethylmorpholines, where “alkyl” is mixture of C11-C14 homologues of which 60-70% is tridecyl; amide fungicides such as N,N′-{piperazine-1,4-diylbis[(trichloromethyl)methylene]}diformamide, 1,1′-piperazine-1,4-diyldi-[N-(2,2,2-trichloroethyl)formamide]; conazole fungicides such as (RS)-(E)-5-(4-chlorobenzylidene)-2,2-dimethyl-1-(1H-1,2,4-triazol-1-ylmethyl)cyclopentanol; triazinylsulfonylurea herbicides such as 1-[4-methoxy-6-(trifluoromethyl)-1,3,5-triazin-2-yl]-3-[2-trifluoromethyl)benzenesulfonyl]urea; dichlorophenyl dicarboximide fungicides; oxazole fungicides such as (RS)-3-(3,5-dichlorophenyl)-5-methyl-5-vinyl-1,3-oxazolidine-2,4-dione.

Pesticides can undergo transformation. This includes in particular chemical reactions such as hydrolysis, oxidation and isomerization. For the purposes of the invention, transformation means especially conversion to other organic compounds. Thus, transformation products of pesticides include in particular reaction products of the pesticide.

Physicochemical properties such as solubility, partition coefficient and stability data, can be found in standard handbooks such The Pesticide Manual, British Crop Protection Council, e.g. the 12^{th} edition 2000.

Pesticidal adjuvants or auxiliaries in particular include those used in emulsifiable concentrates, suspoemulsions and suspension concentrates. Pesticidal adjuvants and auxiliaries include surfactants, dispersants, wetters, thickeners, organic solvents, cosolvents, antifoams, carboxylic acids, preservatives, stabilizers, extenders and sticking agents.

In this context, the term “surfactant” refers to interface- or surface-active agents. Surfactants include anionic, cationic, amphoteric and nonionic surfactants, furthermore polymer surfactants and surfactants with heteroatoms in the hydrophobic group.

The anionic surfactants include, for example, carboxylates, in particular alkali metal, alkaline earth metal and ammonium salts of fatty acids, for example potassium stearate, which are usually also referred to as soaps; acyl glutamates; sarcosinates, for example sodium lauroyl sarcosinate; taurates; methylcelluloses; alkyl phosphates, in particular alkyl esters of mono- and diphosphoric acid; sulfates, in particular alkyl sulfates and alkyl ether sulfates; sulfonates, furthermore alkylsulfonates and alkylarylsulfonates, in particular alkali metal, alkaline earth metal and ammonium salts of arylsulfonic acids and of alkyl-substituted arylsulfonic acids, alkylbenzenesulfonic acids, such as, for example, lignosulfonic acid and phenolsulfonic acid, naphthalene- and dibutylnaphthalenesulfonic acids, or dodecylbenzenesulfonates, alkylnaphthalenesulfonates, alkyl methyl ester sulfonates, condensates of sulfonated naphthalene and derivatives thereof with formaldehyde, condensates of naphthalenesulfonic acids, phenol- and/or phenolsulfonic acids with formaldehyde or with formaldehyde and urea, mono- or dialkyl sulfosuccinates; and protein hydrolyzates and lignin-sulfite waste liquors.

The cationic surfactants include, for example, quaternized ammonium compounds, in particular alkyltrimethylammonium halides, dialkyldimethylammonium halides, alkyltrimethylammonium alkyl sulfates, dialkyldimethylammonium alkyl sulfates and pyridine and imidazoline derivatives, in particular alkylpyridinium halides.

The nonionic surfactants include, for example, further alkoxylates, mainly ethoxylates, and nonionic surfactants, in particular fatty alcohol polyoxyethylene esters, for example lauryl alcohol polyoxyethylene ether acetate, alkyl polyoxyethylene ethers and alkyl polyoxypropylene ethers, for example of linear fatty alcohols, alkylaryl alcohol polyoxyethylene ethers, for example octylphenol polyoxyethylene ether, alkoxylated animal and/or vegetable fats and/or oils, for example corn oil ethoxylates, castor oil ethoxylates, tallow fat ethoxylates, glycerol esters such as, for example, glycerol monostearate, fatty alcohol alkoxylates and oxo alcohol alkoxylates, alkylphenol alkoxylates such as, for example, ethoxylated isooctylphenol, octylphenol or nonylphenol, tributylphenyl polyoxyethylene ethers, fatty amine alkoxylates, fatty acid amide alkoxylates and fatty acid diethanolamide alkoxylates, in particular their ethoxylates, sugar surfactants, sorbitol esters such as, for example, sorbitan fatty acid esters (sorbitan monooleate, sorbitan tristearate), polyoxyethylene sorbitan fatty acid esters, alkylpolyglycosides, N-alkylgluconamides, alkylmethyl sulfoxides, and alkyldimethylphosphine oxides such as, for example, tetradecyldimethylphosphine oxide.

The amphoteric surfactants include, for example, sulfobetaines, carboxybetaines and alkyldimethylamine oxides, for example tetradecyldimethylamine oxide.

The polymeric surfactants include, for example, di-, tri- and multi-block polymers of the type (AB)x, ABA and BAB, for example optionally end-capped ethylene oxide/propylene oxide block copolymers, for example ethylenediamine-EO/PO block copolymers, polystyrene block polyethylene oxide, and AB comb polymers, for example polymethacrylate comb polyethylene oxide.

Further surfactants to be mentioned in the present context by way of example are perfluoro surfactants, silicone surfactants, for example polyether-modified siloxanes, phospholipids such as, for example lecithin or chemically modified lecithins, amino acid surfactants, for example N-lauroylglutamate, and surface-active homo- and copolymers, for example polyvinylpyrrolidone, polyacrylic acids in the form of their salts, polyvinyl alcohol, polypropylene oxide, polyethylene oxide, maleic anhydride/isobutene copolymers and vinylpyrrolidone/vinyl acetate copolymers.

Pestcidal adjuvants and auxiliaries further include solvents or diluents, emulsifiers, delayed-release agents, pH buffers, and antifoams.

Examples are mineral oils, synthetic oils, vegetable oils and animal oils, and low-molecular-weight hydrophilic solvents such as alcohols, ethers, ketones and the like.

These include aprotic or apolar solvents or diluents, such as mineral oil fractions of medium to high boiling point, for example kerosene and diesel oil, furthermore coal tar oils, hydrocarbons, paraffin oils, for example C8- to C30-hydrocarbons of the n- or isoalkane series or mixtures of these, optionally hydrogenated or partially hydrogenated aromatics or alkylaromatics from the benzene or naphthalene series, for example aromatic or cycloaliphatic C7- to C18-hydrocarbon compounds, aliphatic or aromatic carboxylic acid esters or dicarboxylic acid esters, or fats or oils of vegetable or animal origin, such as mono-, di- and triglycerides, in pure form or in the form of a mixture, for example in the form of oily extracts of natural materials, for example olive oil, soya oil, sunflower oil, castor oil, sesame seed oil, corn oil, groundnut oil, rapeseed oil, linseed oil, almond oil, castor oil, safflower oil, and their raffinates, for example hydrogenated or partially hydrogenated products thereof and/or their esters, in particular the methyl and ethyl esters.

Examples of C8- to C30-hydrocarbons of the n- or isoalkane series are n- and isooctane, -decane, -hexadecane, -octadecane, -eicosane, and preferably hydrocarbon mixtures such as liquid paraffin (technical-grade liquid paraffin may comprise up to approximately 5% aromatics) and a C18-C24 mixture which is commercially available from Texaco under the name Spraytex oil.

The aromatic or cycloaliphatic C7 to C18 hydrocarbon compounds include, in particular, aromatic or cycloaliphatic solvents from the series of the alkylaromatics. These compounds may be unhydrogenated, partially hydrogenated or fully hydrogenated. Such solvents include, in particular, mono-, di- or trialkylbenzenes, mono-, di- or trialkyl-substituted tetralins and/or mono-, di-, tri- or tetraalkyl-substituted naphthalenes (alkyl is preferably C1-C6-alkyl). Examples of such solvents are toluene, o-, m-, p-xylene, ethylbenzene, isopropylbenzene, tert-butylbenzene and mixtures, such as the Exxon products sold under the names Shellsol and Solvesso, for example Solvesso 100, 150 and 200.

Examples of monocarboxylic esters are oleic esters, in particular methyl oleate and ethyl oleate, lauric esters, in particular 2-ethylhexyl laurate, octyl laurate and isopropyl laurate, isopropyl myristate, palmitic esters, in particular 2-ethylhexyl palmitate and isopropyl palmitate, stearic esters, in particular n-butyl stearate and 2-ethylhexyl 2-ethylhexanoate.

Examples of dicarboxylic esters are adipic esters, in particular dimethyl adipate, di-n-butyl adipate, di-n-octyl adipate, di-iso-octyl adipate, also referred to as bis(2-ethylhexyl)adipate, di-n-nonyl adipate, diisononyl adipate and ditridecyl adipate; succinic esters, in particular di-n-octyl succinate and diisooctyl succinate, and di(isononyl)cyclohexane 1,2-dicarboxylate.

Residual amounts of dangerous or pesticidal compounds usually mean trace amounts of dangerous or pesticidal compounds. Accordingly, the plastic sample usually comprises less than 10% by weight, less than 5% by weight, less than 1% by weight, less than 0.5% or less than 0.1% by weight, in particular less than 500 ppm by weight, or less than 100 ppm by weight, and especially less than 50 ppm by weight, less than 10 ppm by weight, less than 1 ppm by weight, less than 0.1 ppm by weight, or less than 0.01 ppm by weight of one or more than one dangerous or pesticidal compound. The method of the present invention can be used to determine trace amounts of 0.0001 ppm by weight or more, in particular more than 0.0005 ppm by weight, and especially more than 0.001 ppm by weight of one or more than one dangerous or pesticidal compound. Thus, the method of the present invention in particular relates to the analysis of samples which are at risk of comprising 0.0001 to 500 ppm by weight, in particular 0.0005 to 100 ppm by weight, and especially 0.001 ppm to 50 ppm of one or more than one dangerous or pesticidal compound. This encompasses compound on the surface of the plastic as well as compound that has migrated into the plastic.

The plastic sample can be any sample derived from plastics that are at risk of containing dangerous or pesticidal residues. As used herein, a plastic sample means a sample that comprises plastic. The term “plastic” as used herein means a material that is based on a polymer or a prepolymer. Polymers or prepolymers are raw materials for plastics; they become plastics after physical compounding and/or chemical reaction and/or hardening. According to a particular embodiment of the present invention, the plastic is a thermoplastic. According to a further particular embodiment of the present invention, the plastic is selected from the group consisting of agricultural waste plastics, in particular those used in packaging. Of particular importance are plastics selected from the group of polyolefins such as polyethylene (PE), especially high-density polyethylene (HDPE) or low density polyethylene (LDPE), or polypropylene, and polyesters such as poly(ethylene terephthalate) (PET). Optionally, polyethylene and in particular high-density polyethylene can be halogenated, especially fluorinated. Further plastics that may be present in conjunction with the aforementioned plastics are polyamides or poly(ethylene vinyl alcohol) or other materials which may be used as barrier materials. Samples comprising high-density polyethylene, in particular those having a density of 940 kg/m³ or more, as well as poly(ethylene terephthalate) are of particular importance according to the present invention.

According to a particular embodiment, the plastic is packaging material or a product derived from such packaging material, e.g. a product comprising recycled packaging material. According to a preferred embodiment, the packaging material is packaging material that has been used for agricultural and especially agrochemical purposes. Especially containers, e.g. jugs, jars or bags, commonly used for agrochemicals are made of plastic. These include containers which essentially consist of one type of plastic, in particular high-density polyethylene or poly(ethylene terephthalate). Further, these also include containers comprising at least two different types of plastic. According to one embodiment, such containers have walls which comprise an inner layer and an outer layer. While the outer layer is preferably a high-density polyethylene, the inner layer preferably comprises plastics selected from polyamide or poly(ethylene vinyl alcohol).

The skilled person will appreciate that plastic samples according to the present invention may comprise constituents other than plastics, for instance common plastic additives such antioxidants, light stabilizers, heat stabilizers, lubricants, mold-release agents, blowing agents, flame retardants, fillers, dyes, pigments, antistatic agents, nucleating agents, optical brighteners, impact modifiers, and plasticizers. According to a particular embodiment, the amount of such additive(s) in the plastic sample of the present invention is less than 50% by weight, in particular less than 10% by weight and especially less than 5%, 4%, 3%, 2%,1%, 0.5%, or 0.1% by weight.

The present invention is especially concerned with a method for determining a pesticidal analyte in agrochemical containers. Thus, the sample that is processed in accordance with the method of the present invention preferably comprises such containers or material thereof. The skilled person will appreciate that said containers may be of different sizes, for instance they may have a volume of 10 L, 5 L, 1 L, or 100 mL, or a weight of about 300 to 400 g,150 to 250 g, 60 to 100 g, or 20 to 25 g. It will also be appreciated that said plastic agrochemical containers are post-consumer products which include functional and non-functional, e.g. deformed or damaged containers, as well as parts thereof. These post-consumer products are also referred to as agricultural waste plastics.

The sample quantity to be processed is determined by the type of plastic and its exposure to the dangerous or pesticidal analyte. Usually, a minimum quantity is required to provide a representative sample. Therefore, the sample quantity is usually at least 500 g, preferably at least 750 g, and, in particular, at least 1000 g, at least 1250 g at least 1500 g, at least 1750 g, at least 2000 g, at least 2500 g, or at least 3500 g plastics. On the other hand, the sample quantity should allow a convenient processing of the sample. Therefore, the sample quantity is usually not more than 25,000 g, in particular not more than 20,000 g and especially not more than 10,000 g. This sample quantity is hereinafter also referred to as the bulk sample.

Processing the sample to a fine powder usually requires subjecting the sample to size reduction. Size reduction, also known as comminution, is defined as the breakdown of solids into smaller particles. Expediently, size reduction is carried out mechanically.

One objective of size reduction is the production of a desired particle size.

There are alternative ways to describe the fine powder in terms of particle size. According to the present invention, the term particle size is used for particle sizes determined by sieve analysis, e.g. using conventional sieves and sieve shakers such as W. S. Tyler sieve shaker. According to the present invention, the term volume-weighted particle size (synonymous: volume-weighted mean particle size) is used for particle sizes determined by optical measurements such as light scattering techniques and in particular laser diffraction, e.g. using conventional laser particle sizing instruments such as Malvern Mastersizer 2000.

In case the particle size is determined by sieve analysis (by shaking appropriate sieves for sufficient time to allow separation of those particle which pass the sieve and those which are retained, e.g. 30 minutes at 300 rpm), a powder having a particle size of 800 μm or less, in particular 700 μm or less, and especially 600 μm or less, 550 μm or less, or 500 μm or less, is considered to be a fine powder and expedient for the purposes of the invention.

According to another aspect, at least 80%, in particular at least 85%, and especially at least 90%, at least 91%, at least 92%, at least 93%, at least 94%, at least 95%, at least 96%, at least 97%, at least 98%, or at least 99% of all particles of said powder have a particle size of less than 600 μm.

According to a particular aspect, at least 80%, in particular at least 85%, and especially at least 90%, at least 91%, at least 92%, at least 93%, at least 94%, at least 95%, at least 96%, at least 97%, at least 98%, or at least 99% of all particles of said powder have a particle size of less than 500 μm.

According to a special aspect, at least 80%, in particular at least 85%, and especially at least 90%, at least 91%, at least 92%, at least 93%, at least 94%, at least 95%, at least 96%, at least 97%, at least 98%, or at least 99% of all particles of said powder have a particle size of less than 400 μm.

In case the particle size is determined by laser diffraction (by measuring the scattering of laser light by the powder in dry state in accordance with ISO 13320-1 (Nov. 1, 1999), e.g. by using Malvern Mastersizer 2000: measuring time 20 seconds, 95% vibration feed rate and a Dispersive Air Pressure of 4), a powder having a volume-weighted particle size of 800 μm or less, in particular 700 μm or less, and especially 600 μm or less, 550 μm or less, or 500 μm or less, is considered to be a fine powder and expedient for the purposes of the invention.

According to another aspect, at least 80%, in particular at least 85%, and especially at least 90%, at least 91%, at least 92%, at least 93%, at least 94%, at least 95%, at least 96%, at least 97%, at least 98%, or at least 99% of all particles of said powder have a volume-weighted particle size of less than 600 μm.

According to a particular aspect, at least 80%, in particular at least 85%, and especially at least 90%, at least 91%, at least 92%, at least 93%, at least 94%, at least 95%, at least 96%, at least 97%, at least 98%, or at least 99% of all particles of said powder have a volume-weighted particle size of less than 500 μm.

According to a special aspect, at least 80%, in particular at least 85%, and especially at least 90%, at least 91%, at least 92%, at least 93%, at least 94%, at least 95%, at least 96%, at least 97%, at least 98%, or at least 99% of all particles of said powder have a volume-weighted particle size of less than 400 μm.

Preferably, size reduction is carried out stepwise. This has the advantage that the means for size reduction can be selected more appropriately, depending on the particle size and consistency of the starting material and the particle size to be achieved. Accordingly, it is preferable to obtain an intermediate material which results from at least one size reduction step and which is subjected to at least one further size reduction step. In accordance with the method of the present invention, said intermediate material is referred to as particulate material. In practice, said particulate material can be processed directly after it is obtained, or stored for further processing later on. If stored, this is preferably done at reduced temperature, e.g. below 0° C.

According to a particular embodiment of the present invention, size reduction comprises a first step of shredding the plastic sample. One objective of this step is to convert the sample to a particulate material that can be conveniently processed to a powder having the desired particle size.

Shredding plastics is well known to those skilled in the art of the processing of plastics, in particular thermoplastics. In particular, shredding may comprise cutting and/or chopping the plastic sample. Cutting may involve the use of a cutting mill and chopping may involve the use of a guillotine.

According to a particular embodiment of the present invention, the plastic sample is converted to a particulate material having a particle size of less than about 10 mm, in particular less than about 5 mm and especially, less than about 4 mm, less than about 3 or less than about 2.5 mm. Due to the type of size reduction carried out in this first step, the particle size will usually be above about 1 mm, in particular above about 1.5 mm and especially above about 2 mm, above about 2.25 or above about 2.5 mm.

According to a further particular embodiment of the present invention, size reduction comprises a second step of milling the particulate material resulting from the first step to yield the fine powder. This milling step can be performed using any device known in the art to produce the desired particle size. According to a preferred embodiment, milling is ultracentrifugal milling and planetery milling. Advantageously, the milling step further comprises sieving the milled material so as to provide a powder having the desired particle size. Milling and sieving can be conveniently combined in one and the same device. For instance, the Retsch® ZM 100 and 200 ultracentrifugal mill has proven especially suitable (the Retsch® ZM 200 ultracentrifugal mill is recommended by the manufacturer for preparing powder samples from plastics for determining heavy metal contaminations by X-ray fluorescence analysis). Other suitable mills include, for instance, mortar grinder LC-102 (Gilson company), SPEX CertiPre 8000M Mixer/Mill (from SPEX CertiPre company), and planetary ball mills made by Retsch (supplied by GlenMills) and Fritsch (supplied by Gilson).

Preferably, only a portion of the particulate material obtained in the first step is subjected to the milling step (second step). Accordingly, the particulate material is divided into at least two portions. The resulting portions can be essentially of the same size (volume or weight) or not. According to the present invention it is preferable that a portion having a weight of at least 10 g, in particular at least 25 g and especially at least 50 g, at least 60 g at least 70 g, at least 80 g, at least 90 g, or at least 100 g, be taken from the particulate material and further processed to the powder. On the other hand, the portion should allow a convenient processing of the particulate material. Therefore, said portion usually has a weight of not more than 200 g, in particular not more than 150 g, and especially not more than 100 g. This portion is hereinafter also referred to as the sub-sample.

Dividing the particulate material into at least two portions can be carried out manually or mechanically. Assuming the particulate material is sufficiently homogenous, portions can be obtained by random sampling. For instance, portions may be obtained by “spooning” and other techniques which involve the random insertion of a spoon or other sampling device into the particulate material. Alternatively, the classic cone-and-quarter technique or so-called splitters such as ruffle splitters, rotary splitters or multiple-cone splitters can be used. In accordance with the cone-and-quarter technique, the particulate material is poured into a cone, the cone is flattened, the flattened cone is divided into four equal parts (quartering) and then two opposite quarters are removed. The remaining two quarters are repiled into a cone and the process is repeated until the desired sample size is obtained.

According to a particular embodiment, size reduction is carried out at reduced temperature. Temperatures below 0° C. and preferably below −20° C. are suitable. Reduced temperatures may be conveniently obtained by using dry ice and/or liquid nitrogen.

The fine powder is then converted into a form accessible for determining the analyte.

Preferably, only a portion of the powder obtained by size reduction is subjected to said conversion. Accordingly, the powder is divided into at least two portions. The resulting portions can be essentially of the same size (volume or weight) or not. According to the present invention it is preferable that a portion having a weight of less than 5 g, in particular less than 1 g and especially less than 0.9 g, less than 0.8 g, less than 0.7 g, less than 0.6 g, less than 0.5 g, less than 0.4 g, less than 0.3 g, less than 0.2 g, less than 0.1 g, or less than 0.05 g be taken from the powder and converted. On the other hand, the portion should allow the determination of the analyte. Therefore, said portion usually has a weight of at least 0.01 g, in particular at least 0.05 g, and especially at least 0.1 g. This portion is hereinafter also referred to as the powder portion or aliquot.

For statistical reasons, it may be expedient to take at least 2, preferably at least 3 and in particular at least 5 powder aliquots.

According to a particularly preferred embodiment of the present invention, at least two powder aliquots are then converted in parallel into a form accessible for determining the analyte. Said powder aliquots may be derived from the same bulk sample or from different bulk samples.

It is a particular advantage of the method of the present invention that the powder portion and in particular each powder aliquot can have a relatively small weight, preferably in the range of 0.001 g to 5 g, more preferably in the range of 0.01 to 1 g and in particular in the range of 0.05 to 0.5 g. This allows miniaturization and thus the use of techniques based on bioanalytical methods.

One objective of converting the powder into a form accessible for determining the dangerous or pesticidal analyte is to separate the analyte to be determined from further powder constituents and/or to render low analyte concentrations determinable by concentration steps. In this regard, wet chemical methods have the advantage of enabling the use of various measuring systems as well as simple calibration by known standards.

Thus, the step of converting the powder into a form accessible for determining the dangerous or pesticidal analyte preferably comprises separating analyte from non-analyte thereby providing the analyte in a form accessible for determining the analyte. Said form provided may contain the analyte in a higher concentration than the powder or may enable its enrichment by further separating analyte from non-analyte. For instance, if said form is a solution containing the analyte, removing solvent enables the enrichment of the analyte.

Techniques for converting a powder into a form accessible for determining a powder constituent (the analyte) are well known to those skilled in the art. Suitable techniques comprise, in particular, extraction of the powder.

According to a particular embodiment of the present invention, converting the powder into a form accessible for determining the analyte comprises providing a solution containing the analyte. Accordingly, the powder is treated with a solvent or a mixture of solvents capable of dissolving the analyte. Treatment with solvent or solvent mixture can comprise treatment with a sequence of different solvents or solvent mixtures, as appropriate. If more than one solvent or solvent mixture is used in sequence, it may be expedient to combine the solutions obtained.

Preferably, the powder is treated with solvent or solvent mixture in order to extract (extraction, optionally multistep extraction) or to elute the analyte. Extraction, optionally multistep extraction, is usually particularly preferred.

The solvent or the solvent mixture to be used for extracting or eluting the analyte depends on both the dangerous or pesticidal analyte and the remaining powder constituents. Based on common general knowledge, the skilled person is in a position to select a solvent or a solvent mixture that allows the separation of the dangerous or pesticidal analyte of the remaining powder constituents so as to provide a solution of the analyte that is accessible for determining the analyte. Separation as used here means an enrichment of the analyte compared to the remaining constituents. In many cases, alcohols such as methanol or ethanol, ethers such as diethylether, dioxane or tetrahydrofurane, ketones such as acetone or cyclohexanone, hydrocarbons such as toluene, xylene, hexane, pentane or cyclohexane, halogenated solvents such as dichloromethane, other polar solvents such as acetonitrile, dimethyl formamide (DMF) and dimethyl sulphoxide (DMSO), mixtures thereof, or mixtures of said solvent(s) with water allow the provision of the dangerous or pesticidal analyte in the form of a suitable solution.

According to a preferred embodiment, the solvent is an ether or a mixture of an ether with a further solvent, hereinafter referred to as co-solvent. An especially suited ether is tetrahydrofurane (THF).

If the solvent is a mixture of an ether with a co-solvent, said co-solvent preferably is a solvent which provides for strong hydrogen bonding. This type of co-solvent includes acidic alcohols, such phenols and halogenated alkanols. Perhalogenated alkanols and in particular perfluorinated alkanols represent special examples of such co-solvents. Especially, co-solvents which are able to penetrate plastics, in particular the plastics mentioned above, e.g. HDPE, are preferred. Even more preferred are co-solvents which are able to at least partially dissolve plastics, in particular the plastics mentioned above, e.g. HDPE. One example of such a co-solvent is a halogenated solvent, hexafluoroisopropanol (HFIP).

Mixtures of THF and HFIP have proven especially suitable for extracting plastics, especially HDPE. Such mixtures can comprise THF:HFIP in relative amounts of 1:99 to 99:1 (by volume). THF containing 0.1 to 50% VN, preferably 0.5 to 25% VN, and in particular 1 to 10% VN, e.g. 5% VN, provide for an efficient extraction of plastics, such as HDPE.

It is a particular advantage of the method of the present invention that the amount of solvent used can be rather small. The use of small amounts of solvent is made possible by the small powder portions or aliquots, as described above. Preferably, less than 500 mL, less than 100 mL, less than 50 mL, less than 25 mL, less than 10 mL, less than 5 mL, less than 2.5 mL, less than 2 mL, less than 1 mL, less than 0.5 mL, or less than 0.25 mL solvent or solvent mixture are used for converting the powder portion or aliquot. For instance, for converting a powder portion or aliquot having a weight in the range of 0.05 to 0.5 g, e.g. about 0.1 g, the amount of solvent or solvent mixture expediently used is from 0.5 to 5 mL, preferably from 1 to 2 mL, e.g. 1.6 mL. In case of a multistep conversion, e.g. the use of more than one solvent or solvent mixture in sequence, it is preferred to use said amounts for each conversion. Said small volumes such as 10 mL or less, preferably 5 mL or less and in particular 1 mL or less, conveniently allow the conversion of more than 1 powder portion or aliquot in parallel. In particular 2 to 24, 2 to 96 or even multiples thereof can be converted in parallel. For instance, 24 well- or even 96 well-microtiter plates can be used conveniently as recipients for carrying out each conversion, e.g. extraction.

The treatment of the powder portion or aliquot in order to extract the analyte usually comprises agitating the powder solvent mixture. Agitating can involve, for instance, shaking or vortexing, or sonicating the sample. It is preferred that the treatment, in particular an extraction, comprises both vortexing and sonicating, expediently in sequence. A treatment comprising vortexing followed by sonicating has proven especially suitable.

The time of treating the powder portion or aliquot is variable. It is usually in the range of minutes to hours. If the treatment comprises both, vortexing and sonicating, it is preferred to start with a relatively short period of vortexing, e.g. 1 min, followed by a relatively long period of sonicating, e.g. 15 minutes.

Usually the treatment is performed at ambient temperature, i.e. in the range of 20 to 30° C. Lower or higher temperatures ranging from the melting to the boiling point of the solvent or solvent mixture used may, however, be expedient. Nonetheless, temperatures of 50° C. or higher are usually not required according to the present invention and thus can usually be avoided.

Further, it is preferred that the treatment is carried out under atmospheric or near atmospheric pressure (about 10⁵ Pa, or in the range of 12 to 20 psi). This includes an increase of pressure that may occur if the treatment is carried out in a sealed vessel and the temperature raises.

Also, it may be expedient to separate the solution from the remaining powder constituents, e.g. by centrifugation, so that the solution or a portion thereof is readily accessible and can be subjected to the subsequent steps. Further means for separating the solution from the remaining powder constituents include filtration.

According to a preferred embodiment, the treatment comprises more than one extraction step, such as 2 or 3 extraction steps. A method which comprises more than one extraction step may require that the solids be separated or solvent or solvent mixture be removed in order to allow for a change of solvent or solvent mixture. Such a method comprises treating the powder with a first solvent or solvent mixture, separating the solids or removing first solvent or first solvent mixture, e.g. by filtration or centrifugation, and treating the remaining solids with a second solvent or second solvent mixture, followed by separating the solids or removing second solvent or second solvent mixture. After said second treatment, the first solvent or first solvent mixture, second solvent or second solvent mixture (the extracts) are combined and the combined extract is processed further. Alternatively, a method which comprises more than one extraction step may not require that the solids be separated or solvent or solvent mixture be removed in between two extraction steps, provided that the change of solvent or solvent mixture can be effected by adding solvent or co-solvent to the solvent or solvent mixture used for the previous extraction so as to form the desired solvent mixture for the subsequent extraction.

According to a particular embodiment, the treatment comprises 2 extraction steps, the first of which is carried out using a first solvent and the second of which is carried out using a solvent mixture, wherein the solvent mixture comprises the first solvent and a co-solvent. In this embodiment, the solvent is preferably an ether, in particular THF, and the co-solvent is preferably a solvent which provides for strong hydrogen bonding, as described above, in particular HFIP.

Determining the analyte usually comprises detecting the analyte. To this end, the form accessible for determining the analyte, e.g. the solution or a portion thereof optionally containing the analyte, is subjected to said determination.

Suitable means for detecting dangerous or pesticidal analytes are well known to those skilled in the art. Many substance- and structure-specific detectors are suitable. Examples are flame-ionization detectors (FID), thermionic detectors (TID), electron-capture detectors (ECD), UV/VIS detectors or diffraction detectors. Mass spectrometry is particularly suitable.

In the method of the present invention, determining preferably comprises (further) separating the analyte prior to its detection. Such a separation can conveniently be performed by chromatography, preferably gas chromatography (GC) or liquid chromatography (LC) such as high-performance liquid chromatography (HPLC).

Moreover, the skilled person will appreciate that (further) separation and detection may be coupled. In particular, the coupling of gas or liquid chromatography with mass spectrometry (GC-MS or LC-MS) is usually suitable for determining the dangerous or pesticidal analyte.

The determination in accordance with the method of the present invention can provide a qualitative or quantitative result. It may further include calibration, for instance by using standard reference materials containing either no dangerous or pesticidal analyte (negative control) or known concentrations of the dangerous or pesticidal analyte (positive control).

Technical guidance on how to detect a pesticidal analyte can also be found in standard handbooks such The Pesticide Manual, British Crop Protection Council, e.g. the 12^{th} edition 2000.

The following non-limiting examples further illustrate the present invention.

### EXAMPLE 1

Determination of residual BAS 346 F, BAS 421 F and BAS 480 F in high-density polyethylene (HDPE) bottles.

Residues of BAS 346 F, BAS 421 F, and BAS 480 F in milled high-density polyethylene have been measured.

Briefly, HDPE bottles were processed to a fine powder. Since according to the European Waste Catalogue (EWC) the threshold value of T+ compounds in post consumer resins (PCRs) is 0.1% the method was designed to determine if the residues levels exceeded 0.1% of the weight of the milled plastic bottle (1000 mg/kg). A 0.1 g powder aliquot was extracted by vortexing with methanol. The residues were determined by HPLC-MS/MS analysis. The method was tested to a level of 100 mg/kg for each analyte.

Plastic bottles were processed to a fine powder by a stepwise reduction in size. The bottles (about 1000 g) were cut into small squares, approximately 2 cm by 2 cm. An aliquot (about 100 g) of these small squares was further reduced in size using a Retsch Ultracentrifugal mill, cooled with liquid nitrogen. The mill was equipped with a 0.2 mm screen, converting the plastic squares into a fine powder which was collected in a side collection vessel. The resulting fine powder was stored frozen in plastic bags until the time of analysis. The milled sample can be further processed by repeating the Ultracentrifugal milling step if necessary.

HDPE bottle powder samples were weighed (100±10 mg) into a 1.4 mL Matrix AlphaNumeric well plate tube (e.g. 96 or other comparable well plate vessel). An exact weight of 100 mg for the treated samples was not necessary as the exact weight was included in the calculations. For procedural recovery samples, appropriate amounts of fortification solution (10 μL of 1.0 mg/mL for BAS 480 F, 7 μL of a 1.4 mg/mL for BAS 421 F, and 50 μL of a 0.2 mg/mL for BAS 346 F) were added to achieve a 0.01% fortification (100 mg/kg). For the 1000 mg/kg samples, fortifications were made with the same standards, however the volume was increased ten-fold. An automated liquid handling system (e.g. Quadra96®, Model 320 or other comparable instrument), was used to add extraction solvent (methanol, 0.8 mL) to each sample.

The tubes were capped firmly with the Matrix SepraSeal caps (or other appropriate cap). Samples were vortexed upside down on a Multitube Vortexer at maximum speed (2400 rpm) for 1.0 minute followed by a vortex cycle right side up at maximum speed for 1.0 minute. Samples were centrifuged at 2000 rpm for 5.0 minutes in a swinging bucket centrifuge.

An aliquot was removed from the supernatant of each extract and diluted appropriately for analysis by HPLC-MS/MS.

The LC-MS/MS analysis were performed on PE Sciex API 4000 Biomolecular Mass Analyzer. For quantitation, the transitions monitored are 192.2→160.2 for BAS 346 F, 304.3→147.2 for BAS 421 F, and 330.1→121.1 for BAS 480 F.

The following table summarizes the analytical results:

| | % Recovery | | |
|---|---|---|---|
| Sample Description | BAS 346 F | BAS 480 F | BAS 421 F |
| Control | — | — | — |
| 0.01% Fortification | 108 | 82 | 99 |
| 0.01% Fortification | 96 | 68 | 92 |
| 0.01% Fortification | 103 | 75 | 97 |
| 0.1% Fortification | 89 | 66 | 83 |
| 0.1% Fortification | 91 | 73 | 85 |
| 0.1% Fortification | 97 | 79 | 94 |

The fortification recoveries at two levels (0.01% and 0.1%) were: 97±7% (n=6) for BAS 346 F, 74±6% (n=6) for BAS 480 F, 92±6% (n=6) for BAS 421 F. No residues we detected from the two treated bottles that had been analyzed in five replicates.

### EXAMPLE 2

Determination of the particle size of the powder produced by size reduction.

A HDPE bottle sample was processed to a powder as described in example 1.

The particle size produced by milling of the HDPE bottle sample was determined by laser diffraction and sieve analysis.

For laser diffraction analysis the Malvern Mastersizer 2000 system was used. The Mastersizer calculates the size of particles by passing the particles through a laser beam, takes a snapshot of how the light is scattered, and back calculates the size of the particle that would produce the light scattering pattern. It is equipped with two lasers; a red laser produced by a Helium/Neon lamp with a maximum output of 5 mW and emits a beam with a 633 nm wavelength, and a blue laser produced by an light emitting diode. For each sample measurement, several thousand snapshots are taken to determine the particle size distribution.

The HDPE powder sample was run on the Mastersizer as a dry powder, an aqueous suspension, and a methanol suspension.

For the dry sample, the measurement time was 20 seconds (20000 snapshots) with a 95% vibration feed rate and the maximum Dispersive Air Pressure of 4. The results are summarized in the following table.

| Particle Size (μm) | %* | Particle Size Range (μm) | % Total |
|---|---|---|---|
| — | — | >399 | 18 |
| <399 | 82 | 317-399 | 18 |
| <317 | 64 | 200-317 | 37 |
| <200 | 27 | 126-200 | 19 |
| <126 | 8 | <126 | 8 |

*The instrument calculates the volume of the sample measured and determines the percentage of the sample by volume that is under given particle size.

For the liquid suspension samples, the measurement time was 12 seconds (12000 snapshots) with 2500 rpm pump stir speed and pre-measurement ultrasonic treatment. The liquid suspensions used for the measurements contain dispersion and wetting agents and were run with water or MeOH as the dispersant in the Malvern 2000. The average of the results are summarized in the following table.

| Particle Size (μm) | %* | Particle Size Range (μm) | % Total |
|---|---|---|---|
| — | — | >399 | 35 |
| <399 | 65 | 317-399 | 13 |
| <317 | 52 | 200-317 | 19 |
| <200 | 33 | 126-200 | 9 |
| <126 | 24 | <126 | 24 |

*The instrument calculates the volume of the sample measured and determines the percentage of the sample by volume that is under given particle size.

Static interaction of the particles was observed during the measurements for the dry measurements and the liquid measurements despite ultrasonic agitation.

For sieve analysis the W. S. Tyler sieve shaker with a Leeson motor was used. The sieve shaker was equipped with a 425 μm, 300 μm, 200 μm, and a 150 μm screen. The sample was shaken 30 minutes at 300 rpm and the particle size distribution was determined by weight. Approximately 85% of the particles are less than 425 μm. The size distribution observed from the sieve shaker is summarized in the table below. The total weight of the samples tested was 34.57 g.

| Screen Size (μm) | Particle Size Range (μm) | Weight (g) | % Total* |
|---|---|---|---|
| 425 | >425 | 5.02 | 14.5 |
| 300 | 300-425 | 16.28 | 47.1 |
| 200 | 200-300 | 6.38 | 18.5 |
| 150 | 150-200 | 5.03 | 14.6 |
| NA | <150 | 1.76 | 5.1 |

| | | |
|---|---|---|
| Total Recovery | 34.47 | 99.8* |

*% Total Recovery based on sum of % Total.

### EXAMPLE 3

Determination of recovery of 1 ppm, 10 ppm and 100 ppm fortifications for 19 pesticides in HDPE and HDPE/polyamide.

HDPE and HDPE/polyamide (coextruded material) powder samples were obtained as described above and treated with appropriate amounts of 19 pesticides to give pesticide fortifications of 1 ppm, 10 ppm and 100 ppm, respectively. A 0.1 g powder aliquot was extracted and the residues were determined by HPLC-MS/MS analysis. The analysis of each treated powder was done in 10 replicates.

The extraction was a 2-step extraction using THF followed by THF/HFIP. Briefly, 1.6 mL THF were added to 0.1 g of treated powder, vortexed for 1 minute, and then sonicated for 15 minutes. In the second step, 1.6 mL THF containing 5% (V/V) HFIP was used (vortexing for 1 minute and then sonicating for 15 minutes). The solids were separated by filtration, and the filtrates from both extraction steps were combined to form the extract.

An aliquot was removed from each extract and diluted appropriately for analysis by HPLC-MS/MS.

The following table summarizes the results obtained:

| | % Recovery ± Standard Deviation | | | | | |
|---|---|---|---|---|---|---|
| | HDPE | | | HDPE/polyamide | | |
| Pesticid | 1 ppm | 10 ppm | 100 ppm | 1 ppm | 10 ppm | 100 ppm |
| Azoxystrobin | 106 ± 11 | 106 ± 4 | 106 ± 5 | 111 ± 6 | 110 ± 6 | 108 ± 6 |
| Boscalid | 96 ± 16 | 117 ± 7 | 117 ± 7 | 112 ± 6 | 116 ± 8 | 114 ± 14 |
| Diflufenican | 112 ± 17 | 117 ± 21 | 115 ± 15 | 95 ± 22 | 109 ± 23 | 100 ± 13 |
| Epoxyconazole | 104 ± 11 | 108 ± 3 | 106 ± 6 | 113 ± 8 | 107 ± 4 | 104 ± 8 |
| Fenpropimorph | 111 ± 9 | 114 ± 5 | 110 ± 6 | 112 ± 6 | 110 ± 4 | 107 ± 8 |
| Flufenacet | 97 ± 16 | 109 ± 5 | 111 ± 6 | 114 ± 7 | 117 ± 3 | 116 ± 9 |
| Flurtamone | 103 ± 9 | 109 ± 4 | 109 ± 2 | 110 ± 6 | 112 ± 5 | 108 ± 7 |
| Imadacloprid | 109 ± 9 | 105 ± 7 | 107 ± 5 | 93 ± 7 | 94 ± 6 | 102 ± 9 |
| Isoproturon | 103 ± 9 | 106 ± 4 | 108 ± 2 | 115 ± 7 | 111 ± 5 | 112 ± 7 |
| Kresoxim-Methyl | 100 ± 18 | 99 ± 20 | 104 ± 21 | 111 ± 16 | 111 ± 15 | 113 ± 25 |
| Mesotrione | 56 ± 9 | 83 ± 9 | 100 ± 7 | 50 ± 5 | 69 ± 4 | 96 ± 8 |
| Metazachlor | 106 ± 9 | 106 ± 2 | 107 ± 4 | 107 ± 4 | 106 ± 4 | 105 ± 6 |
| Propiconazole | 111 ± 15 | 111 ± 15 | 117 ± 15 | 104 ± 17 | 95 ± 8 | 110 ± 8 |
| Pyraclostrobin | 105 ± 10 | 106 ± 2 | 107 ± 3 | 113 ± 4 | 110 ± 5 | 106 ± 7 |
| Quinmerac | 71 ± 7 | 94 ± 4 | 98 ± 5 | 49 ± 8 | 64 ± 4 | 89 ± 7 |
| S-Metolachlor | 106 ± 11 | 105 ± 7 | 107 ± 5 | 115 ± 5 | 109 ± 4 | 108 ± 6 |
| Tebuconazole | 108 ± 16 | 105 ± 4 | 110 ± 9 | 115 ± 7 | 106 ± 7 | 102 ± 7 |
| Terbuthylazin | 102 ± 12 | 112 ± 4 | 113 ± 4 | 119 ± 5 | 116 ± 4 | 116 ± 9 |
| Trifloxystrobin | 100 ± 11 | 108 ± 6 | 108 ± 3 | 116 ± 5 | 114 ± 5 | 110 ± 7 |

As can be seen, the recoveries are consistently about 100% for a wide range of fortifications for the pesticides tested.

1-29. (canceled)

30. Method for determining a dangerous analyte in plastics, which comprises processing a plastic sample to a powder having a particle size of 800 μm or less, treating the powder or a portion thereof with solvent capable of dissolving the analyte thereby providing a solution that contains the analyte, and determining the analyte.

31. The method of claim 30, wherein the dangerous analyte is a T+ compound.

32. The method of claim 31, wherein the T+ compound is selected from the group consisting of 2-ethylhexanoic acid chloride, isononanoic acid chloride, neodecanoic acid chloride, hydrofluoric acid, atropine sulfate, scopolamine hydrobromide, 13-acetyldigoxine, epinephrine bitartrate, pilocarpine hydrochloride, hyoscyamine sulfate, hyoscyamine hydrobromide, atropine methylnitrate, alkylated phenol, dimethylsulfate, p-chloro-o-nitroaniline, and 5-chloro-2-nitroaniline.

33. Method for determining a pesticidal analyte in plastics, which comprises processing a plastic sample to a powder having a particle size of 800 μm or less, treating the powder with solvent capable of dissolving the analyte thereby providing a solution that contains the analyte, and determining the analyte.

34. The method of claim 33, wherein the pesticidal analyte is a pesticide.

35. The method of claim 30, wherein the sample comprises less than 1% by weight of the dangerous or pesticidal analyte.

36. The method of claim 30, wherein the plastic sample is agricultural waste plastic.

37. The method of claim 30, wherein the plastic sample comprises poly(ethylene), poly(propylene) or poly(ethylene terephthalate).

38. The method of claim 30, wherein the sample has a weight in the range of 500 to 25.000 g.

39. The method of claim 30, wherein the processing of the sample comprises subjecting the sample to size reduction.

40. The method of claim 39, wherein size reduction comprises a first step of shredding the sample to yield a particulate material and a second step of milling the particulate material to yield the fine powder.

41. The method of claim 40, wherein the particulate material has a particle size of 1.0 to 2000 mm.

42. The method of claim 40, wherein milling is ultracentrifugal milling.

43. The method of claim 40, wherein milling is performed at reduced temperature.

44. The method of claim 30, wherein particle size is determined by sieve analysis.

45. The method of claim 44, wherein the powder has a particle size of 700 μm or less, or of 600 μm or less.

46. The method of claim 30, wherein the powder has a volume-weighted particle size of 800 μm or less, of 700 μm or less, or of 600 μm or less.

47. The method of claim 30, wherein a portion of the powder is treated with solvent, the portion having a weight of less than 1 g.

48. The method of claim 47, wherein at least two portions are treated in parallel.

49. The method of claim 30, wherein treating the powder with solvent comprises extracting the analyte by means of a solvent or solvent mixture.

50. The method of claim 49, wherein the analyte is extracted by means of a sequence of solvents or solvent mixtures.

51. The method of claim 49, wherein the amount of solvent or solvent mixture used is less than 1 mL for each extraction.

52. The method of claim 30, wherein determining the analyte comprises detecting the analyte.

53. The method of claim 52, wherein detecting the analyte is realized by mass spectrometry.
